(19) United States
(12) Patent Application Publication
(10) Pub. No.: US 2015/0358043 A1
(43) Pub. Date: Dec. 10, 2015

(54) WEARABLE DEVICE, MAIN UNIT OF WEARABLE DEVICE, FIXING UNIT OF WEARABLE DEVICE, AND CONTROL METHOD OF WEARABLE DEVICE

(71) Applicant: Samsung Electronics Co., Ltd., Suwon-si (KR)

(72) Inventors: Hee Yeon Jeong, Seoul (KR); Jung Su Ha, Osan-si (KR); Bong-Gyo Seo, Suwon-si (KR)

(73) Assignee: Samsung Electronics Co., Ltd., Suwon-si (KR)

(21) Appl. No.: 14/730,543

(22) Filed: Jun. 4, 2015

(30) Foreign Application Priority Data
Jun. 5, 2014 (KR) 10-2014-0068196
May 11, 2015 (KR) 10-2015-0065366

(51) Int. Cl. H04B 1/3827; H04W 4/00; H04W 76/02; H04W 12/06

(52) U.S. Cl. CPC H04B 1/385; H04W 12/06; H04W 4/008; H04W 76/023

(57) ABSTRACT

A wearable device and a control method of the wearable device includes a replaceable fixing unit configured to transfer pre-stored user interface (UI) data to a main unit, and the main unit configured to provide interaction according to the transferred UI data.

### CROSS-REFERENCE TO RELATED APPLICATIONS

This application claims the priority benefit of Korean Patent Application No. 10-2014-0068196 filed on Jun. 5, 2014 in the Korean Intellectual Property Office and Korean Patent Application No. 10-2015-0065366, filed on May 11, 2015, in the Korean Intellectual Property Office, the disclosures of which are incorporated herein by reference.

### BACKGROUND

1. Field

The following description relates to a wearable device and a control method of the wearable device.

2. Description of the Related Art

Wearable devices can be freely worn like clothing, watches, or glasses on human bodies. These wearable devices include smartglasses, talking shoes, smartwatches, and the like.

Among these, the smartwatch is an embedded system wristwatch equipped with further improved functions than the general watch. Conventionally, the smartwatch is limited to a basic calculation function, a translation function, and a game function. However, in recent years, with the spread of smartphones, an interactive smartwatch for accommodating the convenience of use of a smartphone and a standalone smartwatch capable of independently performing a smartphone function have appeared.

However, because the importance of the Internet of Things (IoT) is being emphasized, users need to individually download and set an application suitable for each thing in conventional smartwatches in relation to the IoT. In relation to this, the conventional smartwatches are inconvenient for users and there are problems in optimization of smartwatch. Accordingly, research is being actively conducted to solve these problems.

In addition, although smartwatches, unlike smartphones, are exposed on the wrists of users and thus significantly relevant to fashion, users have ignored conventional smartwatches because research has focused on only technical and functional aspects in the conventional smartwatches, and uniform designs of the conventional smartwatches have not satisfied the needs of consumers. Thus, research on improved smartwatch designs and research on smartwatch designs suitable for preferences of individual consumers are being actively conducted.

### SUMMARY

Additional aspects and/or advantages will be set forth in part in the description which follows and, in part, will be apparent from the description, or may be learned by practice of the invention.

Therefore, it is an aspect of the present disclosure to provide a wearable device and a control method of the wearable device for automatically downloading and executing an application or the like suitable for each thing without individually downloading an application.

According to an exemplary embodiment, a wearable device may include a replaceable fixing unit configured to transfer pre-stored user interface (UI) data to a main unit; and the main unit configured to provide interaction according to the transferred UI data.

According to the exemplary embodiment, the main unit may be switched to the interaction according to the UI data when the transferred UI data is received.

According to the exemplary embodiment, the main unit may display a graphical user interface (GUI) according to the transferred UI data. According to the exemplary embodiment, the main unit may include a first memory configured to store transferred current and previous UI data and the main unit may provide interaction according to at least one of pieces of the current UI data and the previous UI data.

According to the exemplary embodiment, the main unit may receive UI data from an external device to provide interaction according to the received UI data.

According to the exemplary embodiment, a power supply unit may be provided in the fixing unit.

According to the exemplary embodiment, the wearable device may further include: a camera and a detection unit provided in at least one of the main unit and the fixing unit.

According to the exemplary embodiment, the fixing unit may include an auxiliary function unit including at least one of a power supply unit, a detection unit, a camera, and a payment module.

According to an exemplary embodiment, a wearable device may include a replaceable fixing unit including a second memory configured to store UI data and a second communication unit configured to transfer the UI data to a main unit; and the main unit including a first communication unit configured to receive the UI data from the second communication unit and a UI state module configured to provide interaction according to the transferred UI data.

According to the exemplary embodiment, in the wearable device, the UI data may start to be transferred when a wireless session between the first communication unit and the second communication unit is established.

According to the exemplary embodiment, in the wearable device, the first communication unit may include a first communication port, the second communication unit may include a second communication port corresponding to the first communication port, and the main unit and the fixing unit may be connected by the first communication port and the second communication port.

According to the exemplary embodiment, in the wearable device, the UI data may start to be transferred when the first communication port is connected to the second communication port.

According to the exemplary embodiment, the main unit may display that the main unit is connected to a data unit when the main unit is connected to the fixing unit.

According to the exemplary embodiment, the main unit may receive an input of whether a currently connected data unit is a previously connected data unit or a newly connected data unit.

According to the exemplary embodiment, the main unit may determine whether a currently connected data unit is a previously connected data unit or a newly connected data unit, and display a determination on a GUI.

According to the exemplary embodiment, when a currently connected data unit is a newly connected data unit, the main unit may receive an input of a pin number of the data unit.

According to the exemplary embodiment, when UI data is received from a currently connected data unit, the main unit may receive an input for switching to interaction according to the received UI data.

According to an exemplary embodiment, a main unit of a wearable device may include a first communication unit configured to receive UI data from a fixing unit; and a UI state module configured to provide interaction according to the received UI data.

According to an exemplary embodiment, a replaceable fixing unit of a wearable device may include a second memory configured to store UI data; and a second communication unit configured to transfer the UI data to a main unit.

According to an exemplary embodiment, a control method of a wearable device may include detecting a connection between a main unit and a fixing unit; transferring UI data of the fixing unit to the main unit when it is determined that the main unit is connected to the fixing unit; and providing interaction according to the transferred UI data.

According to an exemplary embodiment, a control method of a wearable device may include detecting a connection between a main unit and a fixing unit; displaying that the main unit is connected to a data unit when it is determined that the main unit is connected to the fixing unit; and transferring UI data of the data unit to the main unit.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view of a wearable device according to an exemplary embodiment.

FIG. 2 is a perspective view of a wearable device according to an exemplary embodiment.

FIG. 3 is a block diagram illustrating a schematic configuration of a wearable device according to an exemplary embodiment.

FIG. 4 is a block diagram illustrating a detailed configuration of the wearable device according to an exemplary embodiment.

FIG. 5 is a block diagram illustrating a schematic configuration of a wearable device according to an exemplary embodiment.

FIG. 6 is a block diagram illustrating a schematic configuration of a wearable device according to an exemplary embodiment.

FIG. 7 is a conceptual diagram in which a first communication unit and a second communication unit are connected by wire by connecting a band and a main unit according to an exemplary embodiment.

FIG. 8 is a conceptual diagram in which a first communication unit and a second communication unit are connected by wire by connecting a casing and the main unit according to an exemplary embodiment.

FIGS. 9A and 9B are conceptual diagrams in which a first communication unit and a second communication unit are connected by wire by connecting a casing and a main unit according to an exemplary embodiment.

FIG. 10 is a conceptual diagram illustrating transmission of UI data in a wireless session between the first communication unit and the second communication unit according to an exemplary embodiment.

FIG. 11 illustrates a concept in which interaction provided by the main unit is switched by a fixing unit according to an exemplary embodiment.

FIG. 12 illustrates a concept in which interaction provided by the main unit is switched by an external data unit according to an exemplary embodiment.

FIG. 13 illustrates a UI indicating that the main unit is connected to the data unit according to an exemplary embodiment.

FIG. 14 illustrates a UI for receiving an input of whether the data unit connected to the main unit is a previously connected data unit or a newly connected data unit according to an exemplary embodiment.

FIG. 15 illustrates a UI for displaying that the previously connected data unit is connected to the main unit according to an exemplary embodiment.

FIG. 16 illustrates a UI for displaying that the newly connected data unit is connected to the main unit according to an exemplary embodiment.

FIG. 17 illustrates a UI for receiving an input of a pin number when the newly connected data unit is connected to the main unit according to an exemplary embodiment.

FIG. 18 illustrates a UI for displaying that UI data is transferred after an authentication procedure when the newly connected data unit is connected to the main unit according to an exemplary embodiment.

FIG. 19 illustrates a UI for receiving an input of whether to perform switching to interaction according to UI data transferred by the newly connected data unit according to an exemplary embodiment.

FIG. 20 illustrates a UI for selecting a type of interaction to be provided by a wearable device according to an exemplary embodiment.

FIGS. 21A, 21B, 21C, 21D, 21E, 21F, 21G, and 21H illustrate a vehicle UI for displaying a GUI on the main unit using vehicle UI data according to an exemplary embodiment.

FIGS. 22A, 22B, and 22C illustrate an exercise UI for displaying a GUI on the main unit using exercise UI data according to an exemplary embodiment.

FIGS. 23A, 23B, 23C, and 23D illustrate a watch brand UI for displaying a GUI on the main unit using watch brand UI data according to an exemplary embodiment.

FIGS. 24A, 24B, 24C, and 24D illustrate a mobile terminal UI for displaying a GUI on the main unit using mobile terminal UI data according to an exemplary embodiment.

FIGS. 25A, 25B, 25C, and 25D illustrate an audio UI for displaying a GUI on the main unit using audio UI data according to an exemplary embodiment.

FIGS. 26A, 26B, 26C, 26D, 26E, 26F, 26G, and 26H illustrate a home appliance UI for displaying a GUI on the main unit using home appliance UI data according to an exemplary embodiment.

FIGS. 27A and 27B illustrate a camera UI for displaying a GUI on the main unit using camera UI data according to an exemplary embodiment.

FIGS. 28 and 29 illustrate a UI for credit card payment using a payment module according to an exemplary embodiment.

FIG. 30 is a flowchart illustrating a method in which the main unit receives UI data through wired communication and displays a GUI according to an exemplary embodiment.

FIG. 31 is a flowchart illustrating a method in which the main unit receives UI data through wireless communication and displays a GUI according to an exemplary embodiment.

FIG. 32 is a flowchart illustrating a method of connecting the main unit to the data unit after an input of whether the data unit is a previously connected data unit or a newly connected data unit is received manually according to an exemplary embodiment.

FIG. 33 is a flowchart illustrating a method of automatically detecting and determining whether the data unit is the previously connected data unit or the newly connected data unit and connecting the main unit to the data unit according to an exemplary embodiment.

### DETAILED DESCRIPTION

Hereinafter, exemplary embodiments of the present disclosure will be described in detail with reference to the accompanying drawings so that the present disclosure may be easily understood and reproduced through the exemplary embodiments by those skilled in the art. In the following description of the present disclosure, a detailed description of known functions and configurations incorporated herein will be omitted when it may make the subject matter of the present disclosure rather unclear.

The terminology used herein is defined by considering a function in the embodiments, and meanings may vary depending on, for example, a user or operator's intentions or customs. Therefore, the meanings of terms used in the embodiments should be interpreted based on the scope throughout this specification. Scientific and technological terms used herein for the present disclosure include meanings generally recognized by those skilled in the art, unless otherwise specified.

Although optional components of exemplary embodiments are illustrated as a single integrated component in the drawings, it should be noted that the components may be freely combined with each other unless technical contradiction is apparent to those skilled in the art.

Hereinafter, exemplary embodiments of a wearable device and a control method of the wearable device will be described with reference to the accompanying drawings.

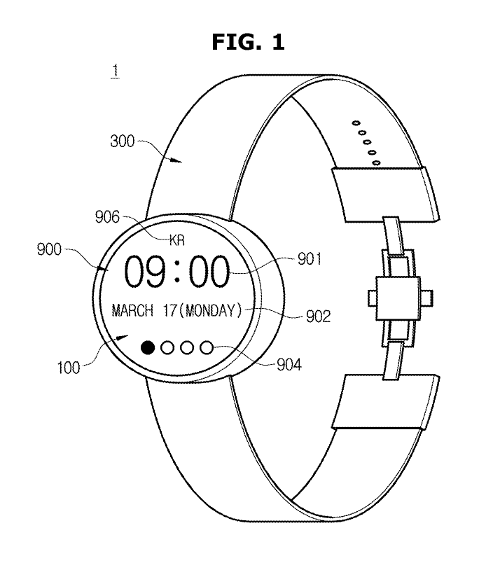

Hereinafter, the exemplary embodiments of the wearable device will be described with reference to FIGS. 1 to 6.

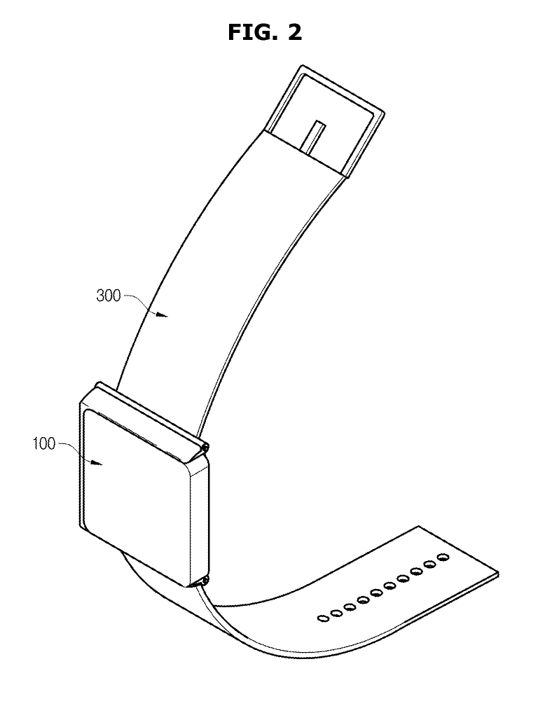

FIGS. 1 and 2 illustrate an exterior of the wearable device.

The wearable device 1 may be worn on a user's wrist, for example, and serves as a device for displaying current time information, displaying information about things, and performing control of the things and other operations. The wearable device 1 may include a main unit 100 for displaying a transmitted GUI, a data unit 200 for transmitting at least one of pieces of UI data to the main unit 100, and a fixing unit 300 for fixing the wearable device 1 to the user's wrist.

Hereinafter, the main unit 100, the GUI data unit 200, and the fixing unit 300 will be specifically described with reference to FIGS. 2 to 5.

Specifically, a current time UI 900 may be implemented in the wearable device 1 as illustrated in FIG. 1. The current time UI may include a time image 901 for displaying a current time, a date image 902 for displaying a current date, a country image 906 for displaying a country in which the wearable device 1 is currently located, and a window position image 904 for displaying a current window position.

Also, in the wearable device 1, the main unit 100 may be circular as illustrated in FIG. 1 or quadrangular as illustrated in FIG. 2.

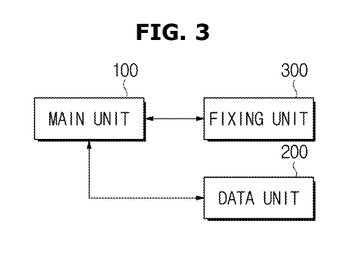

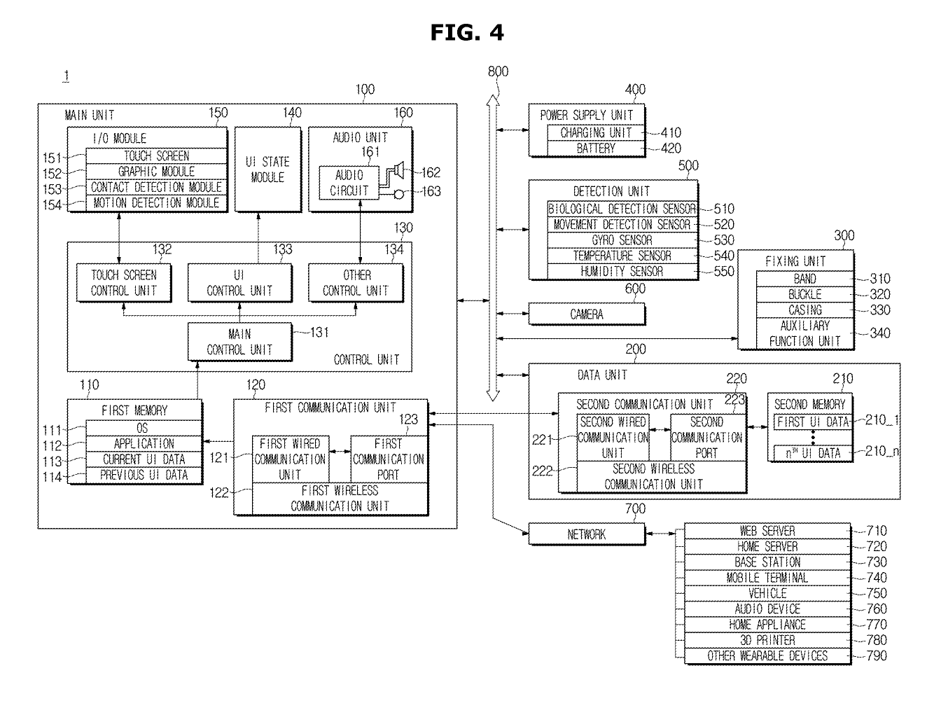

FIG. 3 illustrates a schematic configuration of a wearable device according to an exemplary embodiment, and FIG. 4 illustrates a detailed configuration of the wearable device according to an exemplary embodiment.

The wearable device 1 may be worn on the user's wrist and may provide current time information and perform information exchange and control through communication with another thing. The wearable device 1 may function as a mobile terminal and is a device capable of implementing other convenient functions. This wearable device 1 may include a main unit 100, a fixing unit 300, a data unit 200, a power supply unit 400, a detection unit 500, a camera 600, and a network 700. The above-described components may be connected to each other through a bus 800.

The main unit 100 performs a state transition operation of a UI using at least one of pieces of UI data received from the data unit 200. In addition, the main unit 100 may display a UI and receive a user input signal.

The main unit 100 may include a first communication unit 120, a first memory 110, a control unit 130, a UI state module 140, an input/output (I/O) module 150, and an audio unit 160.

The first communication unit 120 may receive at least one of pieces of UI data from the second communication unit 220 of the data unit 200 and transfer the received UI data to the control unit 130 and the first memory 110. In addition, the first communication unit 120 may be connected to the network 700 and may communicate with a web server 710, communicate with a base station 730, and communicate with other things.

Specifically, the first communication unit 120 may be connected to the network 700 by wire or wireless and may exchange data with the web server 710, a home server 720, the base station 730, a mobile terminal 740, a vehicle 750, an audio device 760, a home appliance 770, a three-dimensional (3D) printer 780, and other wearable devices 790.

That is, the first communication unit 120 may be connected to the web server 710 and may perform web surfing, download an application 112 from a central server, and perform other operations through the Internet. In addition, the first communication unit 120 may be connected to the home server 720 and may view a state of a home appliance within the home, control the home appliance, display a video of the inside of the home, and perform opening/closing of a front door and other operations. In addition, the first communication unit 120 may be directly connected to the base station 730 and can directly perform transmission and reception of a short message service (SMS) and other operations. In addition, the first communication unit 120 may be directly connected to the mobile terminal 740 and may indirectly perform transmission and reception of an SMS and other operations and display and control an operation of the connected mobile terminal. In addition, the first communication unit 120 may be connected to the vehicle 750 and may display external and internal states of the vehicle, a vehicle location, a smartkey, and a video of the inside of the vehicle and perform other operations. In addition, the first communication unit 120 may be connected to an audio device 760 and may display the remaining battery capacities of a speaker, an earphone, and a headphone, control them, and perform other operations. In addition, the first communication unit 120 may be connected to the home appliance 770 and directly perform state display and control of the home appliance and the like without a connection to the home server 720. In addition, the first communication unit 120 may be connected to the 3D printer 780 to display a 3D drawing, and may display a current print progress state, a required time, and the remaining time and perform a notice for supplement of a printing material and other operations. In addition, the first communication unit 120 may communicate with a card terminal through magnetic secure transmission (MST) as well as NFC to perform card payment of the user. In addition, the first communication unit 120 may be connected to other wearable devices 790 to perform information exchange with the other wearable devices 790 and other operations.

The first communication unit 120 may include a first wired communication unit 121, a first wireless communication unit 122, and a first communication port 123.

The first wired communication unit 121 may be connected to the second communication unit 220 of the data unit 200 by wire through the first communication port 123.

Specifically, the first wired communication unit 121 may be electrically connected to the first communication port 123 and the second communication port 223 to receive at least one of pieces of UI data stored in the second memory 210 of the data unit 200 by wire and store the at least one of the pieces of the UI data which has been received in the first memory 110 or transfer the at least one of the pieces of the UI data which has been received to the control unit 130 so that a GUI is displayed on the main unit 100 using the at least one of the pieces of the UI data which has been received.

The first wireless communication unit 122 transmits and receives an electromagnetic wave. The first wireless communication unit 122 converts an electrical signal into an electromagnetic wave or converts the electromagnetic wave into the electrical signal and communicates with the second wireless communication unit 222 of the data unit 200 and the network 700 through the electromagnetic wave obtained through the conversion.

Specifically, although the first wireless communication unit 122 includes an antenna system, a radio frequency (RF) transceiver, one or more amplifiers, a tuner, one or more oscillators, a digital signal processor, a coder/decoder (CODEC) chipset, a subscriber identity module (SIM) card, a memory, and the like, the present disclosure is not limited thereto. The first wireless communication unit 122 may include well-known circuits for performing functions of the above-described components.

In addition, the first wireless communication unit 122 may communicate with the second wireless communication unit 222 of the data unit 200 and a network using networks such as the Internet called World Wide Web (WWW) and an intranet, and/or wireless networks such as a cellular telephone network, a wireless local area network (LAN) and/or a metropolitan area network (MAN) and wireless communication.

The wireless communication may include protocols for a global system for mobile communication (GSM), an enhanced data GSM environment (EDGE), wideband code division multiple access (WCDMA), code division multiple access (CDMA), time division multiple access (TDMA), Bluetooth, Bluetooth Low Energy (BLE), near field communication (NFC), Zigbee, wireless fidelity (Wi-Fi) (For example, Institute of Electrical and Electronics Engineers (IEEE) 802.11a, IEEE 802.11b, IEEE 802.11g, and/or IEEE 802.11n), voice over Internet protocol (VoIP), worldwide interoperability for microwave access (Wi-MAX), Wi-Fi direct (WFD), an ultra-wideband (UWB), infrared data association (IrDA), e-mail, instant messaging, and/or SMS or other proper communication protocols. In addition, various wireless communication schemes may be used as examples of the wireless communication.

In addition, the first wireless communication unit 122 may use at least one of the aforementioned wireless communication schemes rather than only one of the aforementioned wireless communication schemes.

The first communication port 123 may be connected to the second communication port 223 of the data unit 200 to receive at least one of pieces of UI data stored in the second memory 210 of the data unit 200 through wired communication and transfer the received UI data to the first wired communication unit 121.

The first communication port 123 may include a pogo pin port, a definition multimedia interface (HDMI) port, a digital video interface (DVI) port, a D-subminiature port, an unshielded twisted pair (UTP) cable port, a universal serial bus (USB) port. In addition, various wired communication ports for receiving at least one of pieces of UI data of the second memory 210 by wire may be used as an example of the first communication port 123.

In addition, the first communication unit 120 checks and determines whether the first communication unit 120 is connected to the second communication unit 220, and receives at least one of pieces of UI data stored in the second memory 210 when the first communication unit 120 is connected to the second communication unit 220.

Specifically, when the UI data is received through the first wired communication unit 121, a connection may be determined by detecting whether the first communication port 123 is electrically connected to the second communication port 223. For example, it is possible to start the reception of UI data when it is detected that the main unit 100 is connected to the casing 330.

In contrast, when UI data is received through the first wireless communication unit 122, the connection may be determined by detecting whether a wireless session is established.

The first memory 110 stores an operating system (OS) 111, an application 112, current UI data 113, and previous UI data 114, and these components may be used to implement an operation of the wearable device 1.

Specifically, the first memory 110 may store the OS 111 to be managed to execute the application 112 in the wearable device 1, the dedicated application 112 initially provided by a manufacturer, an externally downloaded universal application 112, the current UI data 113 downloaded through a connection between the current data unit 200 and the main unit 100, and the previous UI data 114 downloaded through a connection between the previous data unit 200 and the main unit 100.

The UI data may be the application 112 stored in the second memory 210 of the data unit 200, a UI related to the application 112, an object (for example, an image, text, an icon, a button, or the like) for providing the UI, user information, a document, databases, or related data.

The first memory 110 may include a read only memory (ROM), a high-speed random access memory (RAM), a magnetic disc storage device, a non-volatile memory such as a flash memory device, or another non-volatile semiconductor memory device.

For example, the first memory 110 may be a semiconductor memory device, and may be a secure digital (SD) memory card, a secure digital high capacity (SDHC) memory card, a mini SD memory card, a mini SDHC memory card, a trans flash (TF) memory card, a micro SD memory card, a micro SDHC memory card, a memory stick, a compact flash (CF), a multimedia card (MMC), a micro MMC, an extreme digital (XD) card, or the like.

In addition, the first memory 110 may include a network attached storage device to be accessed through the network 700.

The control unit 130 transfers a control signal to each driving unit so that the operation of the wearable device 1 is executed according to a command input by the user. In addition, the control unit 130 performs a function of controlling an overall operation and a signal flow of internal components of the wearable device 1 and processing data. In addition, the control unit 130 controls power supplied by the power supply unit 400 to be transferred to the internal components of the wearable device 1. In addition, the control unit 130 controls the OS 111 and the application 112 stored in the first memory 110 to be executed, and controls the UI state module 140 so that a UI state transitions using the current UI data 113 or the previous UI data 114.

The control unit 130 functions as a central processing unit (CPU) and a type of CPU may be a microprocessor. The microprocessor may be a processing device equipped with an arithmetic logic unit, a register, a program counter, a command decoder, a control circuit, or the like.

In addition, the microprocessor may include a graphic processing unit (GPU) (not illustrated) for graphic processing of an image or a video. The microprocessor may be implemented in the form of a system on chip (SoC) including a core (not illustrated) and the GPU (not illustrated). The microprocessor may include a single core, a dual core, a triple core, a quad core, etc.

In addition, the control unit 130 may include a graphic processing board including a GPU, a RAM, or a ROM in a separate circuit board electrically connected to the microprocessor.

The control unit 130 may include a main control unit 131, a UI control unit 133, a touch screen control unit 132, and another control unit 134.

The main control unit 131 transfers an overall control signal for an operation of the wearable device 1 to components to be driven, that is, the UI control unit 133, the touch screen control unit 132, and the other control unit 134.

Specifically, the main control unit 131 may detect a connection between the first communication unit 120 and the second communication unit 220 and control at least one of pieces of UI data of the second memory 210 to be transferred to the main unit 100. In addition, the main control unit 131 determines whether the at least one of the pieces of the UI data of the second memory 210 is stored in the first memory 110. When it is determined that the same data is not stored in the first memory 110, the main control unit 131 may control the at least one of the pieces of the UI data of the second memory 210 to be transferred to the main unit 100 or control the transferred UI data to be stored in the first memory 110.

In addition, the main control unit 131 may control the OS 111 and the application 112 stored in the first memory 110 to be executed. In addition, the main control unit 131 may transfer a control signal to the UI control unit 133 so that the UI state module 140 causes a UI state to transition using the current UI data 113.

In addition, the main control unit 131 may transfer a control signal to the UI control unit 133 so that the UI state module 140 causes the UI state to transition using the current UI data 113 or the previous UI data 114. In this case, whether to display a GUI using the current UI data 113 and whether to display a GUI using the previous UI data 114 may be determined according to a user's input, UI data having a UI for a thing from which information is obtained or which is controlled, and another situation.

In addition, the main control unit 131 may produce and transfer a control signal for driving components of the wearable device 1 such as the touch screen 151, the speaker 162, the camera 600, and the UI state module 140 based on a user-input signal input through an input device such as the touch screen 151 or the microphone 163.

The UI control unit 133 may receive the control signal of the main control unit 131 and control the UI state module 140 so that the UI state transitions using selected UI data.

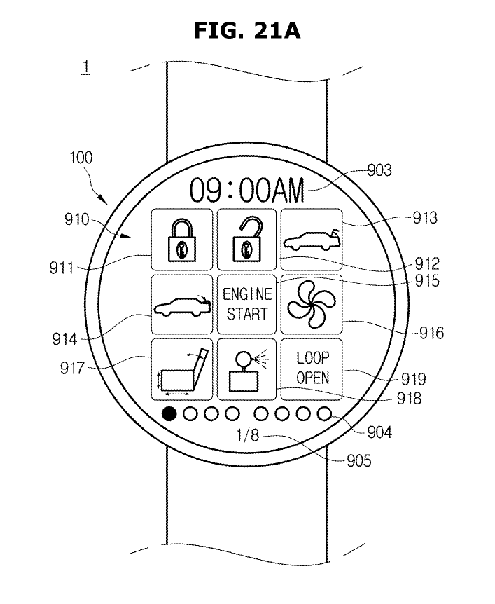

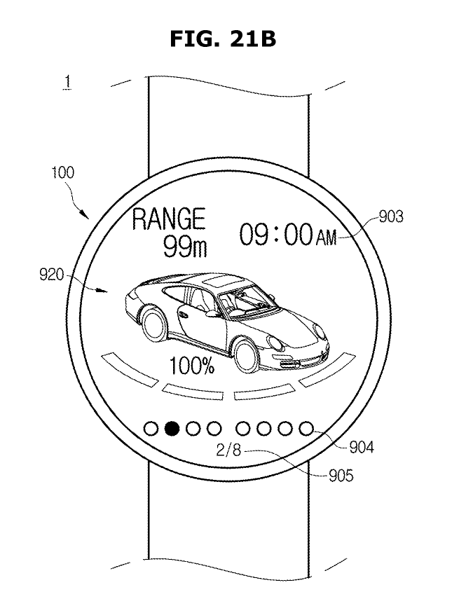

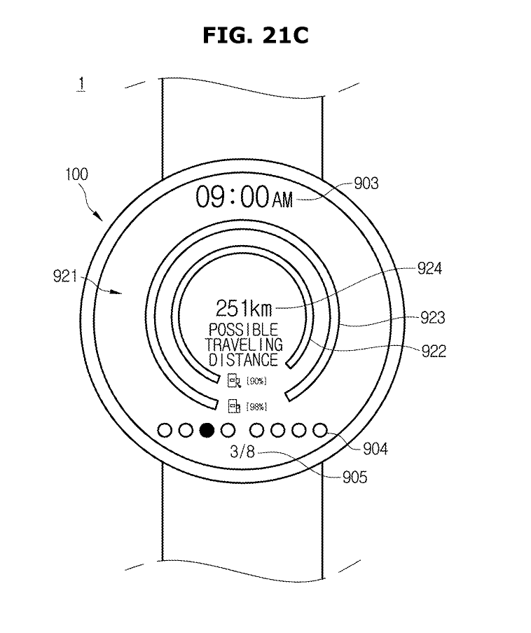

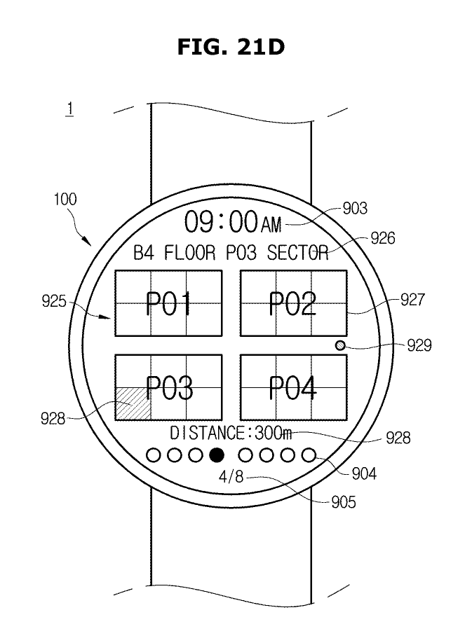

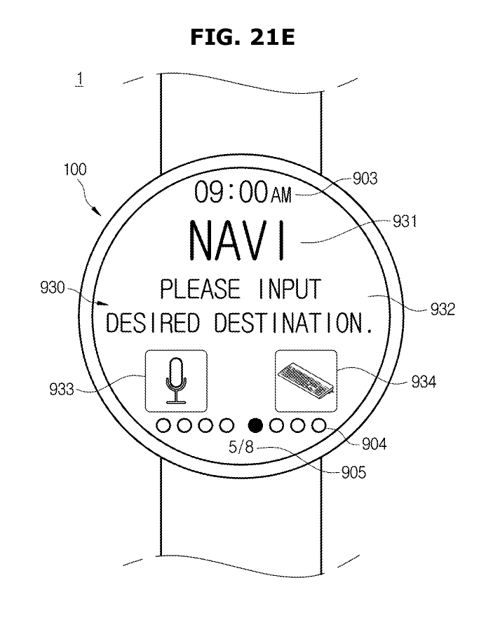

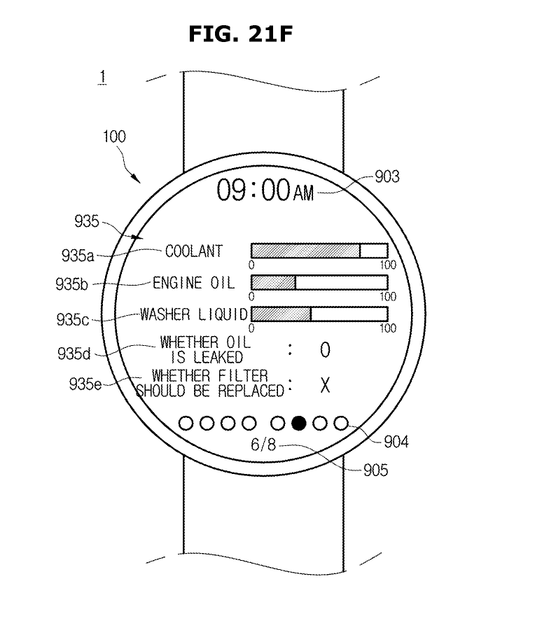

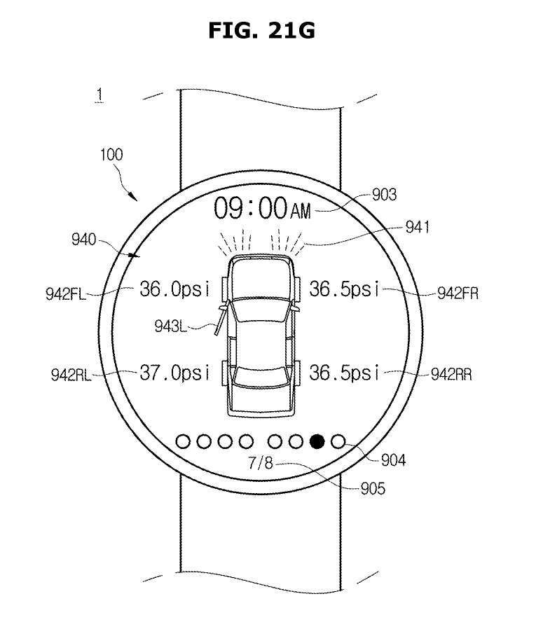

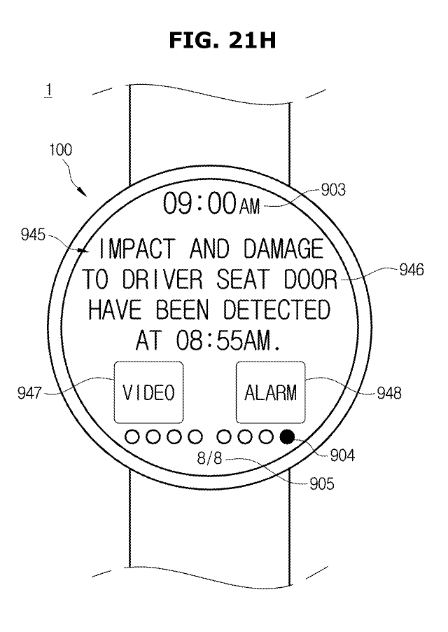

For example, when the selected UI data is related to a vehicle, the UI control unit 133 may control the UI state module 140 so that the wearable device 1 transitions to a vehicle-related UI state using vehicle-related UI data as illustrated in FIGS. 21A to 21H.

The touch screen control unit 132 may transfer a user input signal of the I/O module 150 to the main control unit 131 or display an image for a UI on the touch screen 151 based on the control signal of the main control unit 131.

The other control unit 134 controls operations of components of the wearable device 1 other than the UI state module 140 and the I/O module 150. For example, the other control unit 134 may perform a control operation so that a voice signal of the user recognized by the microphone 163 is transferred to the main control unit 131 or a voice signal is generated from the speaker 162 based on a control signal of the main control unit 131.

The UI state module 140 causes a UI state of the wearable device 1 to transition or to be executed according to the control signal of the UI control unit 133.

Specifically, the UI state module 140 may enable the state transition to a UI for UI data using the selected UI data and execute the UI.

For example, the UI state module 140 may cause the wearable device 1 to transition to a vehicle UI, an exercise UI, a watch brand UI, a mobile terminal UI, an audio UI, a home appliance UI, a camera UI, or the like according to the selected UI data.

Hereinafter, a UI to transition will be described with reference to FIGS. 21A to 29.

The I/O module 150 controls the touch screen 151 and the other I/O devices and outputs of the devices and detects an input.

Specifically, the I/O module 150 may include a touch screen 151, a graphic module 152, a contact detection module 153, and a motion detection module 154.

The touch screen 151 receives an input signal from the user based on haptic or tactile contact. The touch screen 151 includes a touch detection surface for receiving a user-input signal. The touch screen 151, the contact detection module 153, and the touch screen control unit 132 detect the contact on the touch screen 151 and perform interaction with a UI target such as at least one soft key displayed on the touch screen 151 according to the detected contact. In addition, a contact point between the touch screen 151 and the user may correspond to a width of at least one finger of the user.

For the touch screen 151, light emitting diode (LED) technology, liquid crystal display (LCD) technology, light emitting polymer display (LPD) technology, or the like may be used. In addition, various display technologies may be used as examples of technology to be used in the touch screen 151.

The touch screen 151 may detect contact, movement, or stop using another element for determining a point of contact with a proximity sensor array or the touch screen 151 as well as a plurality of touch detection technologies such as capacitive, resistive, infrared, and surface acoustic wave technologies.

In addition, the user may contact the touch screen 151 using an appropriate thing such as a stylus or a finger or an attachment.

The graphic module 152 controls text, a web page, an icon (for example, a UI target including a soft key), a digital image, a video, an animation and all other targets capable of being displayed to the user to be displayed on the touch screen 151. The graphic module 152 may include various software for providing and displaying graphics on the touch screen 151.

In addition, the graphic module 152 may include an optical intensity module. The optical intensity module serves as a component for controlling an optical intensity of a graphic target such as a UI target displayed on the touch screen 151, and controlling the optical intensity in the optical intensity module may include increasing/decreasing the optical intensity of the graphic target.

The contact detection module 153 detects contact with the touch screen 151 along with the touch screen control unit 132. The contact detection module 153 transfers the detected contact with the touch screen 151 to the motion detection module 154.

The motion detection module 154 detects the motion of the contact on the touch screen 151 along with the touch screen control unit 132. The motion detection module 154 may include various software components for performing various operations related to the contact with the touch screen 151, for example, a determination of whether there is contact, a determination of whether contact movement and movement across the touch screen 151 are tracked, and a determination of whether contact stops (when the contact stops). A determination for contact point movement may include a velocity (magnitude), a speed (magnitude and direction), or acceleration (magnitude and direction) of a contact point.

The audio unit 160 provides an audio interface between the user and the wearable device 1.

Specifically, the audio unit 160 may output an audio signal for an operation of the wearable device 1 to the user based on the control signal of the other control unit 134 or receive an audio signal from a peripheral interface to convert the audio signal into an electrical signal and transfer the electrical signal to the control unit 130.

The audio unit 160 may include an audio circuit 161, a speaker 162, and a microphone 163.

The audio circuit 161 receives a control signal from the other control unit 134 to convert the control signal into an electrical signal and transmit the electrical signal to the speaker 162. In addition, the audio circuit 161 receives the electrical signal obtained through the conversion in the microphone 163 and transfers the received electrical signal to the other control unit 134.

In addition, the audio circuit 161 may convert the electrical signal into audio data and transmit the audio data to a peripheral interface. The audio data may be retrieved from the first memory 110 or an RF circuit by the peripheral interface and transmitted by the peripheral interface.

In addition, the audio circuit 161 may include a headset jack. The headset jack provides an interface between the audio circuit 161 and a removable peripheral I/O device, for example, a dedicated headphone for an output or a headset having both an output (single- or dual-ear headphone) and an input (microphone 163).

The speaker 162 converts an electrical signal received from the audio circuit 161 into a sound wave and provides an audio signal to the user.

The microphone 163 detects sound waves around the user and the other wearable device 1, converts the detected sound waves into an electrical signal, and provides the electrical signal to the other control unit 134.

The fixing unit 300 provides a fixing force so that the wearable device 1 is fixed to the wrist of the user. The fixing unit 300 may include bands 310, a buckle 320, a casing 330, and an auxiliary function unit 340.

The bands 310 may be formed in the form of a plurality of straps to surround the user's wrist, have one end fixed by the buckle 320, and provide the fixing force to the user's wrist. In addition, the bands 310 may have a storage structure provided between the other ends to which the main unit 100 is connected.

The bands 310 may have flexibility so that the bands 310 are worn on the user's wrist. Specifically, the bands 310 may be injection-molded with a flexible polymer material or formed of leather. Also, nonslip projections of polymer materials may be formed on an inner side of the band 310 in contact with the user's wrist. In addition, various materials having flexibility for providing the fixing force to the user's wrist may be used as an example of a material of the bands 310.

The buckle 320 may be connected between the ends of the bands 310 to generate a fixing force to the wrist of a wearer and used to adjust the length of the band 310 so that the length of the bands 310 is proper for the thickness of the wrist of the wearer.

Specifically, the buckle 320 may have at least one connection projection, which may be inserted into at least one connection hole formed in the band 310, and connect the bands 310 to provide the fixing force to the user's wrist. In addition, as illustrated in FIG. 1, the buckle 320 may have a hinge member and provide the fixing force to the user's wrist while the radius of the bands 310 is narrowed by the rotation of the hinge member. In addition, the buckle 320 connects the ends of the bands 310 and various forms of the buckle 320 for generating the fixing force to be provided to the user's wrist may be used as an example.

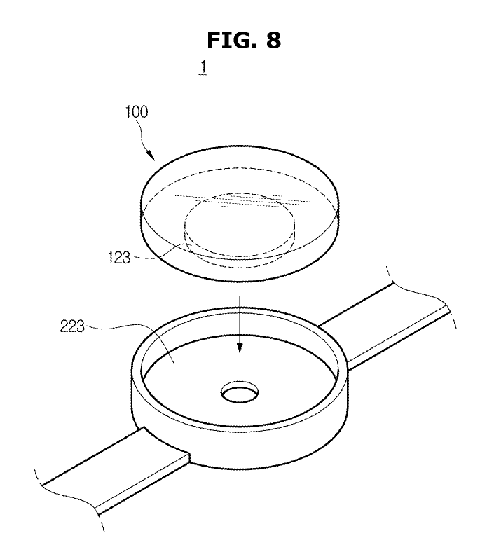

The casing 330 may be a storage structure for seating and fixing the main unit 100 to the fixing unit 300 as illustrated in FIG. 8.

The casing 330 may have a projection or groove corresponding to a shape of the side surface of the main unit 100. In addition, the casing 330 may be formed of a flexible material so that coupling and fixing to the main unit 100 are facilitated. For example, the casing 330 may be formed of a polymer material. In addition, various shapes and materials for seating and fixing the main unit 100 may be used as an example of the casing 330.

The auxiliary function unit 340 may be a storage structure in which a configuration for performing an auxiliary function of the wearable device 1 may be stored.

The auxiliary function unit 340 may be equipped with a data unit 200, a power supply unit 400, a detection unit 500, and a camera 600 and may perform functions of these components. In addition, a component for performing a specific function to be implemented in the wearable device 1 may be provided in the auxiliary function unit 340.

In addition, the auxiliary function unit 340 includes a tag and a company name of a manufacturer manufacturing corresponding bands or the trademark of a corresponding product may be marked on the tag. In addition, various forms of tags for securing visibility may be marked by marking a specific character on the auxiliary function unit 340.

In addition, the auxiliary function unit 340 may be provided in the bands, the buckle 320, or the casing 330 of the fixing unit 300. In addition, various positions at which a function to be implemented by a corresponding component provided in the auxiliary function unit 340 is smoothly performed may be used as an example of a position at which the auxiliary function unit 340 is provided.

The data unit 200 may be a device for transferring at least one of pieces of UI data which has been stored to the main unit 100. The data unit 200 may be included in the fixing unit 300 or provided outside the fixing unit 300. The data unit 200 may include a second memory 210 and a second communication unit 220.

The second memory 210 stores at least one of pieces of UI data for displaying a GUI on the main unit 100.

Specifically, the second memory 210 stores at least one of pieces of UI data for providing a UI for an individual thing and the stored UI data is transferred to the main unit 100 through the second communication unit 220.

The at least one of the pieces of the UI data of the second memory 210 may be information for implementing the UI according to the corresponding data unit 200, and the number of pieces of the UI data may be one or more. For example, the at least one of the pieces of the UI data may include first UI data 210_1 to n^{th} UI data 210_{—}n.

The type of second memory 210 may be the same as or different from the first memory 110 described with reference to FIG. 4.

The second communication unit 220 transfers the at least one of the pieces of the UI data stored in the second memory 210 to the main unit 100.

Specifically, when it is determined that the second communication unit 220 is connected to the first communication unit 120, at least one of pieces of UI data stored in the second memory 210 is transferred to the main unit 100 and the main unit 100 is configured to display a GUI using the UI data of the second memory 210. In addition, when the second communication unit 220 determines that at least one of the pieces of the UI data of the second memory 210 is the same as UI data stored in the first memory 110, the UI data may not be transmitted to the first communication unit 120.

In addition, the second communication unit 220 may include a second wired communication unit 221, a second wireless communication unit 222, and a second communication port 223.

Types and communication schemes of the second wired communication unit 221 and the second wireless communication unit 222 and the like may be the same as or different from those of the first wired communication unit 121 and the first wireless communication unit 122.

The second communication port 223 has a shape capable of being physically and electrically coupled in correspondence with the shape of the first communication port 123. In addition, the type of second communication port 223 may be the same as or different from the type of first communication port 123.

In addition, the data unit 200 may be provided inside the fixing unit 300 so that a design of a watch is changed and the UI for a corresponding thing is implemented when the user replaces the fixing unit 300. That is, the data unit 200 may be provided inside the band 310, provided in the buckle 320, or provided in the casing 330.

In addition, the data unit 200 may be provided in the buckle 320 and the auxiliary function unit 340 which are replaceable so that the main unit 100 transitions to the UI for the corresponding thing may be performed while the user maintains the design of the band 310.

In addition, the data unit 200 may be located in the vicinity of a corresponding thing outside the fixing unit 300 so that the main unit 100 may transition to the UI for the corresponding thing. For example, when the data unit 200 is related to a specific vehicle, the data unit 200 is located in the specific vehicle and the main unit 100 may transition to a UI for the specific vehicle when the user approaches the vehicle.

In addition, a manufacturer of the data unit 200 may be the same as that of the main unit 100. The data unit 200 may be developed and manufactured by a company that develops and manufactures the UI for the corresponding thing or the like. The data unit 200 may be developed and manufactured in a company which develops and manufactures the corresponding thing.

The power supply unit 400 transfers externally supplied electrical energy to each component of the wearable device 1 to provide energy necessary for driving the component or converts chemical energy into electrical energy to transfer the electrical energy to each component of the wearable device 1 and provide energy necessary for driving the component. In addition, the power supply unit 400 may be constituted by a charging unit 410 and a battery 420.

The charging unit 410 may supply power to one or more batteries 420 disposed in the main unit 100 or the fixing unit 300 of the wearable device 1 according to control of the control unit 130. In addition, the charging unit 410 may supply the wearable device 1 with power input from an external power source through a wired cable connected to a connector.

The one or more batteries 420 are provided to supply the power to the components of the wearable device 1. In addition, the battery 420 may be provided inside the main unit 100, provided in the fixing unit 300, or provided in both the main unit 100 and the fixing unit 300 for a large capacity. In addition, the battery 420 may be a flexible battery and a flexible lithium secondary battery may be used as the battery 420.

In addition, the power supply unit 400 may include a power error detection circuit, a converter, an inverter, a power state indicator (for example, a light-emitting diode), and other components related to power generation, management, and distribution in a mobile device.

The detection unit 500 detects biological information of the user, motion, and various types of situations necessary for implementing the function of the wearable device 1 and may be used to implement the function of the wearable device 1 and control the wearable device 1.

For example, the detection unit 500 may include a biological detection sensor 510, a movement detection sensor 520, a gyro sensor 530, a temperature sensor 540, and a humidity sensor 550.

The biological detection sensor 510 detects a body state of the user. Specifically, the biological detection sensor 510 may measure a heart rate, a body temperature, a blood pressure, blood sugar, inflammation, and body fat of the user.

The movement detection sensor 520 detects the movement of the user wearing the wearable device 1. Specifically, the movement detection sensor 520 may detect the movement of the user by detecting a movement speed and direction of the user using an acceleration sensor and converting the movement speed and direction of the user into the movement of the user. In addition, the movement detection sensor 520 may receive radio waves from a plurality of global positioning system (GPS) satellites on the earth's orbit and calculate a position, a movement distance, or the like of the wearable device 1 using a time of arrival of the radio waves from the GPS satellite to the wearable device 1. In addition, the movement detection sensor 520 may calculate a transmission/reception time of a signal between the directional antenna of each base station and the wearable device 1, instantaneously detect the position of the wearable device 1, and detect the movement of the user using the calculated time. For example, it is possible to measure a distance from each base station and detect the position and the movement using a triangulation method.

The gyro sensor 530 measures the inertia of the wearable device 1. Specifically, the gyro sensor 530 may measure the current inertia of the wearable device 1 and detect the position and direction of the wearable device 1, the motion of the user wearing the wearable device 1, and the like.

The temperature sensor 540 and the humidity sensor 550 may measure a temperature and a humidity of a region in which the wearable device 1 is currently located or measure a body temperature of the user and a temperature of the wearable device 1.

In addition, the detection unit 500 may include a proximity sensor for detecting proximity to the wearable device 1 of the user, a luminance sensor for detecting an intensity of light around the wearable device 1, and the like. The detection unit 500 may generate a signal corresponding to the detection and transmit the generated signal to the control unit 130. The sensor of the detection unit 500 may be added or deleted according to performance of the wearable device 1.

The camera 600 supports capturing a still image and a moving image of an object. The camera 600 photographs any given object according to control of the control unit 130 and transfers captured image data to the touch screen 151 and the control unit 130.

In addition, the camera 600 may be provided in the main unit 100, provided in the fixing unit 300, or provided in both the main unit 100 and the fixing unit 300.

In addition, the camera 600 may include a camera sensor for converting an input light signal into an electrical signal, a signal processing unit for converting an electrical signal input from the camera sensor into digital image data, and an auxiliary light source (for example, a flashlight) for providing a light intensity necessary for capturing the image.

The camera sensor may include a sensor using a scheme of a charge-coupled device (CCD), a complementary metal-oxide-semiconductor (CMOS), or the like.

An example of the wearable device 1 described above with reference to FIGS. 3 and 4 is the case in which the data unit 200, the detection unit 500, and the camera 600 are provided separate from the fixing unit 300.

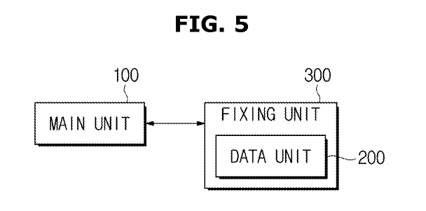

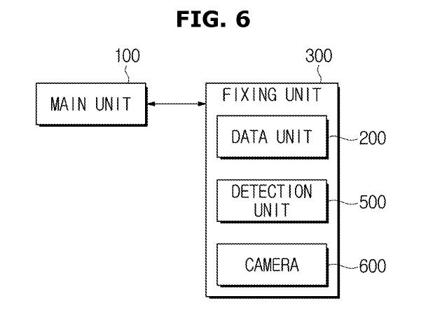

However, the data unit may be included in the fixing unit as illustrated in FIG. 5 and the data unit, the detection unit, and the camera may be included in the fixing unit as illustrated in FIG. 6. In this case, functions and shapes of each components of the wearable device may be the same as or different from those described with reference to FIGS. 3 and 4.

In addition, the data unit, the detection unit, the camera, and the payment module may be provided at various positions.

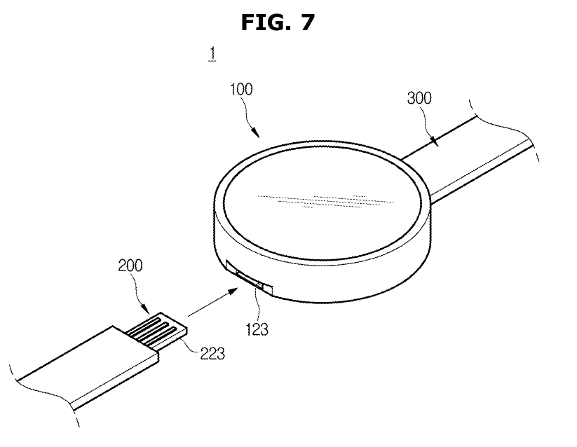

Hereinafter, an exemplary embodiment in which the UI data is transmitted between the data unit and the main unit of the wearable device will be described with reference to FIGS. 7 to 10.

FIG. 7 is a conceptual diagram in which the first communication unit 120 and the second communication unit are connected by wire by connecting the band and the main unit.

As illustrated in FIG. 7, the first communication port 123 and the second communication port 223 are configured as universal serial bus (USB) ports. The first communication port 123 and the second communication port 223 may be formed to be physically and electrically connected in correspondence with each other. In addition, the data unit 200 may be provided in the band 310.

Accordingly, when the second communication port 223 is connected to the first communication port 123, the main unit 100 may detect the connection between the first communication port 123 and the second communication port 223 and at least one of pieces of UI data stored in the second memory 210 may be transferred to the main unit 100 through the first communication port 123 and the second communication port 223 when the connection is made. For example, the second wired communication unit 221 may transmit a connection detection signal to the first wired communication unit 121, and the first wired communication unit 121 may determine that the first communication port 123 is connected to the second communication port 223 when the connection detection signal is recognized.

Thereafter, the main unit 100 may display a GUI using at least one of pieces of UI data which has been transferred.

FIG. 8 is a conceptual diagram in which the first communication unit and the second communication unit are connected by wire by connecting the casing and the main unit.

As illustrated in FIG. 8, the fixing unit 300 may be integrally formed so that the band 310 and the casing 330 are not detachable, and the first communication port 123 and the second communication port 223 are formed to be physically and electrically connected in correspondence with each other. In addition, the data unit 200 may be provided in the casing 330 or the band 310.

Accordingly, when the second communication port 223 is connected to the first communication port 123 by connecting the main unit 100 and the casing 330, the main unit 100 detects the connection between the first communication port 123 and the second communication port 223. When the connection is made, at least one of pieces of UI data stored in the second memory 210 may be transferred to the main unit 100 through the first communication port 123 and the second communication port 223. For example, the second wired communication unit 221 may transmit the connection detection signal to the first wired communication unit 121 and the first wired communication unit 121 may determine that the first communication port 123 is connected to the second communication port 223 when the connection detection signal is recognized.

Thereafter, the main unit 100 may display a GUI using at least one of pieces of UI data which has been transferred.

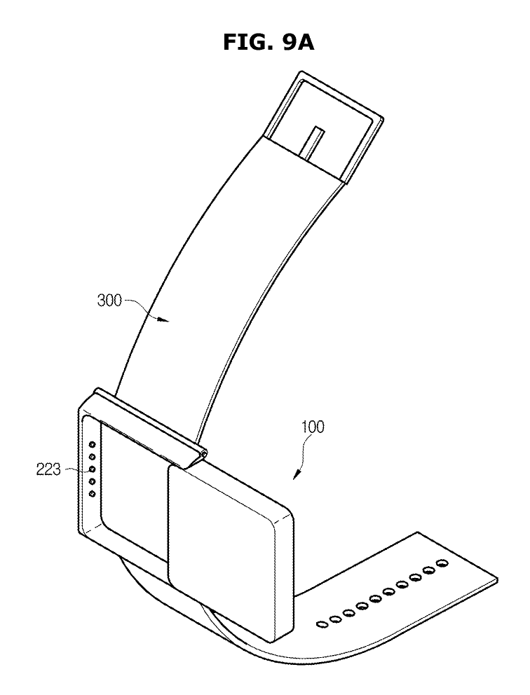

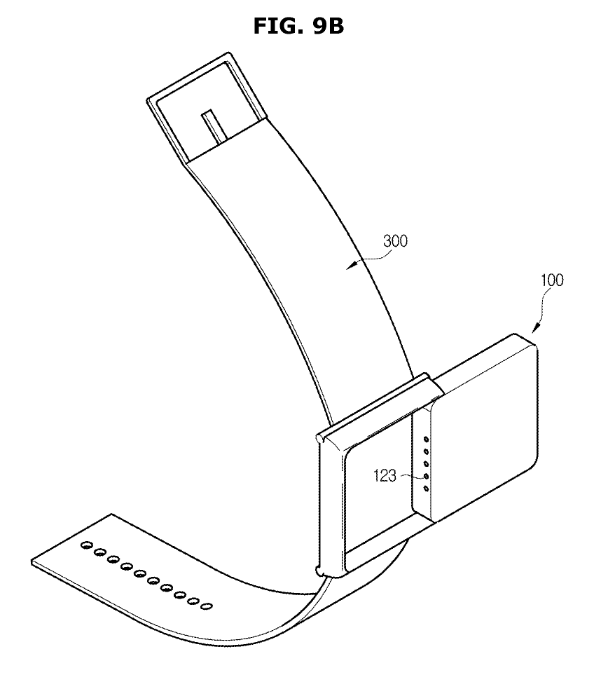

FIGS. 9A and 9B illustrate an example of a concept in which the first communication unit and the second communication unit are connected by wire by connecting the casing and the main unit.

As illustrated in FIGS. 9A and 9B, the fixing unit 300 may be integrally formed so that the band 310 and the casing 330 are not detachable, and the first communication port 123 and the second communication port 223 are formed to be physically and electrically connected in correspondence with each other. In addition, the data unit 200 may be provided in the casing 330 or the band 310.

In addition, the first communication port 123 and the second communication port 223 may be connected in correspondence with each other as pogo pins. Specifically, when the main unit 100 is coupled to and seated in the casing 330 in a slide type as illustrated in FIGS. 9A and 9B, an opening of the casing 330 and the second communication port 223 positioned on the other side are coupled to the first communication port 123 of the main unit 100, so that the data unit 200 and the main unit 100 may be electrically connected.

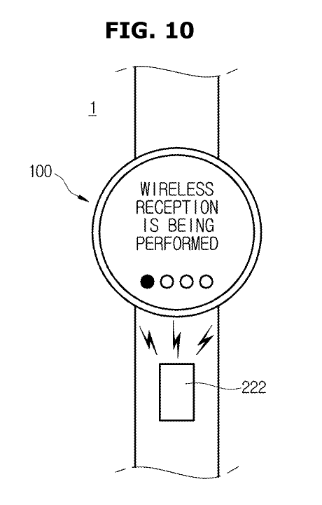

FIG. 10 illustrates a concept of transmission of UI data in a wireless session between the first communication unit and the second communication unit.

As illustrated in FIG. 10, the fixing unit 300 and the main unit 100 are configured not to be detachable. The auxiliary function unit 340 may be provided on one band 310 and the data unit 200 may be provided in the auxiliary function unit 340.

Accordingly, when the first wireless communication unit 122 and the second wireless communication unit 222 establish the wireless session, the second wireless communication unit 222 may transfer at least one of pieces of UI data stored in the second memory 210 to the first wireless communication unit 122. For example, the second wireless communication unit 222 transmits a connection detection signal to the first wireless communication unit 122, and the first wireless communication unit 122 may determine that the first wireless communication unit 122 and the second wireless communication unit 222 establish the wireless session when the connection detection signal is recognized.

Thereafter, the main unit 100 may display a GUI using at least one of pieces of UI data which has been transferred.

When the at least one of the pieces of the UI data described above is transferred to the main unit 100, the touch screen 151 of the main unit 100 may display that wireless transmission is being performed through an image as illustrated in FIG. 10.

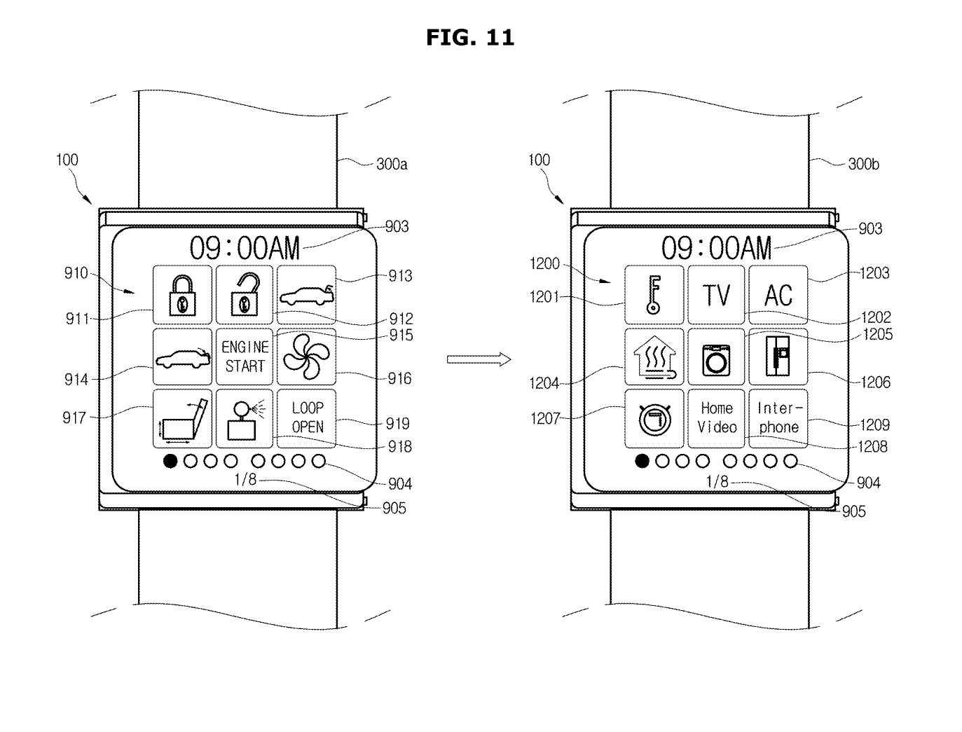

Hereinafter, an exemplary embodiment in which interaction of the main unit is converted according to the fixing unit connected to the main unit will be described with reference to FIG. 11.

As illustrated in FIG. 11, when the main unit 100 may provide interaction for the vehicle when a fixing unit 300a including the data unit 200 storing UI data for the vehicle is connected to the main unit 100.

In addition, when the fixing unit 300a related to the vehicle is separated from the main unit 100 and a fixing unit 300b including the data unit 200 storing UI data for a home appliance is connected to the main unit 100, the main unit 100 may provide interaction for the home appliance.

In addition, even when the UI data for the home appliance is received, the main unit 100 may provide previous interaction for the vehicle according to the user's selection. In addition, thereafter, the main unit 100 may perform conversion into interaction for the home appliance according to necessity of the user.

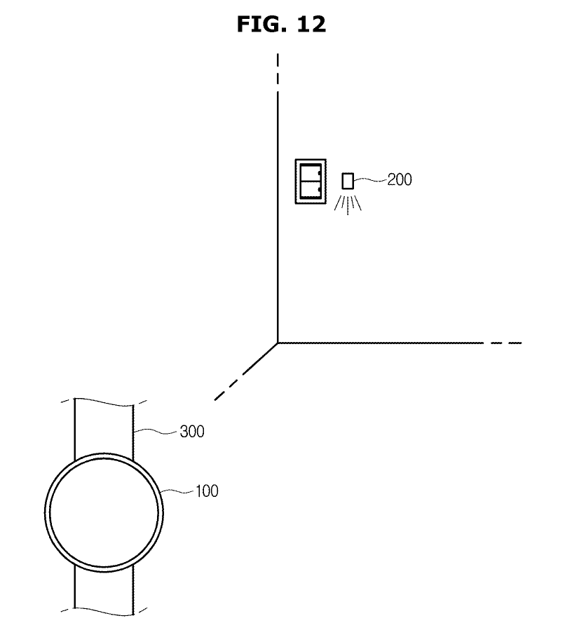

Hereinafter, an exemplary embodiment in which UI data is received from an external data unit and conversion into the corresponding UI data is performed will be described with reference to FIG. 12.

FIG. 12 illustrates a concept in which interaction provided by the main unit 100 may be switched by the external data unit 200 according to an exemplary embodiment.

As illustrated in FIG. 12, when a wireless session is established between the second wireless communication unit 222 of the data unit 200 and the first wireless communication unit 122 of the main unit 100, the data unit 200 may transfer UI data stored in the second memory 210 to the main unit 100. Accordingly, the main unit 100 may provide the corresponding interaction based on the transferred UI data.

Specifically, data obtained by measuring the dust, humidity, and temperature within a home may be transferred to the main unit 100 and data obtained by viewing the number of foods and types of foods within a refrigerator may be transferred to the main unit 100.

The configuration of the wearable device and the transmission of at least one of pieces of UI data stored in the data unit to the main unit have been described above.

Hereinafter, examples of a GUI when the data unit is connected to the main unit and a GUI displayed on the main unit according to a type of UI data stored in the data unit will be described.

In addition, a type of UI implemented in the wearable device is not limited to an example of the UI to be described below.

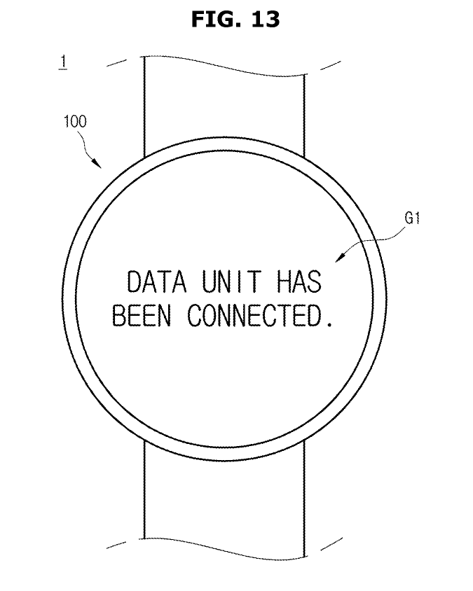

FIG. 13 illustrates a UI indicating that the main unit is connected to the data unit according to an exemplary embodiment.

As illustrated in FIG. 13, when it is recognized that the data unit 200 is connected or when it is input that the data unit 200 is connected to the main unit 100 according to a command of the user, the main unit 100 may provide a GUI G1 indicating that the data unit 200 has been connected to the main unit 100.

Specifically, when it is recognized that the fixing unit 300 equipped with the data unit 200 is connected to the main unit 100, it may be determined that the main unit 100 is connected to the data unit 200. Accordingly, the main unit 100 may provide text indicating “Data unit has been connected” on the touch screen 151.

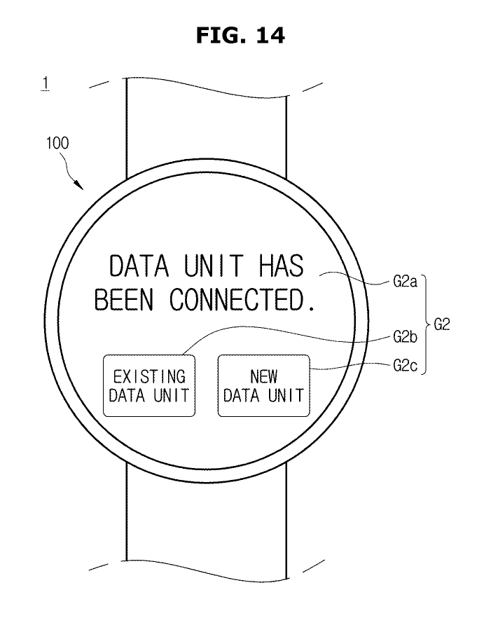

FIG. 14 illustrates a UI for receiving an input of whether the data unit connected to the main unit is a previously connected data unit or a newly connected data unit according to an exemplary embodiment.

As illustrated in FIG. 14, the main unit 100 may provide a GUI G2 so that an input specifying a type of currently connected data unit 200 may be received while displaying text indicating that the data unit 200 has been connected.

The GUI G2 of this exemplary embodiment may include data unit connection text G2a, an existing data unit selection window G2b, and a new data unit selection window G2c.

The main unit 100 may provide text indicating “Data unit has been connected” on the touch screen 151 to provide the user with a message indicating that the main unit 100 is connected to the data unit 200 in the data unit connection text.

The existing data unit selection window G2b may be a button to be selected when the data unit 200 currently connected to the main unit 100 is connected to the existing main unit 100 and UI data is stored within the main unit 100. When the user selects the existing data unit selection window G2b, interaction may be provided through previously stored UI data.

The new data unit selection window G2c may be a button to be selected when the data unit 200 currently connected to the main unit 100 has not previously been connected to the main unit 100 and no UI data is stored within the main unit 100. When the user selects the new data unit selection window G2c, the UI data stored in the data unit 200 currently connected to the main unit 100 may be configured to be transferred to the main unit 100 and the main unit 100 may provide interaction according to the transferred UI data.

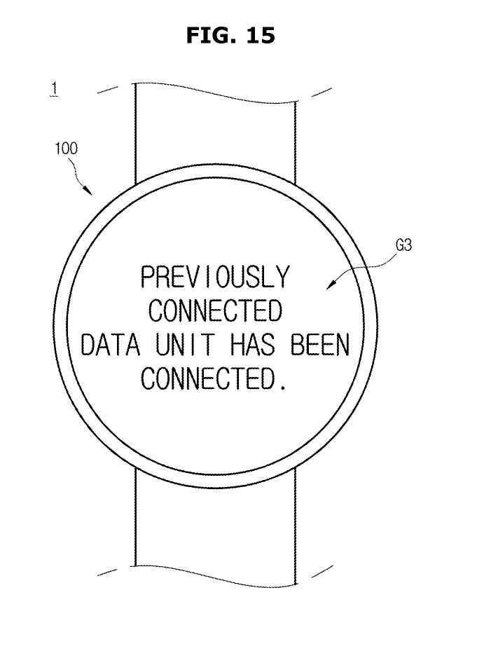

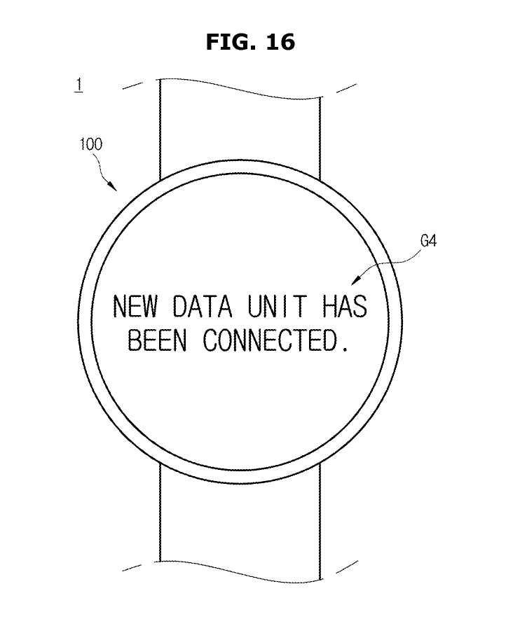

FIG. 15 illustrates a UI for displaying that the previously connected data unit is connected to the main unit according to an exemplary embodiment, and FIG. 16 illustrates a UI for displaying that the newly connected data unit is connected to the main unit according to an exemplary embodiment.

The user may not select whether the data unit 200 currently connected to the main unit 100 is the previously connected data unit or the newly connected data unit, and the main unit 100 may provide a GUI G3 as illustrated in FIG. 15 and a GUI G4 as illustrated in FIG. 16 when the main unit 100 independently recognizes the connected data unit.

Specifically, when the main unit 100 recognizes that the currently connected data unit 200 is a previously connected data unit or when the UI data stored in the first memory 110 of the main unit 100 is included in the currently connected data unit 200, the main unit 100 may provide the GUI G3 for providing a notification of a recognition result as illustrated in FIG. 15.

In this case, the main unit 100 may provide text indicating “Previously connected data unit has been connected” to the touch screen 151.

In contrast, when the main unit 100 recognizes that the currently connected data unit 200 is a newly connected data unit or when data matching UI data stored in the currently connected data unit 200 is not stored in the first memory 110 of the main unit 100, the main unit 100 may provide the GUI G4 for providing a notification of a recognition result as illustrated in FIG. 16.

In this case, the main unit 100 may provide text indicating “Newly connected data unit has been connected” to the touch screen 151.

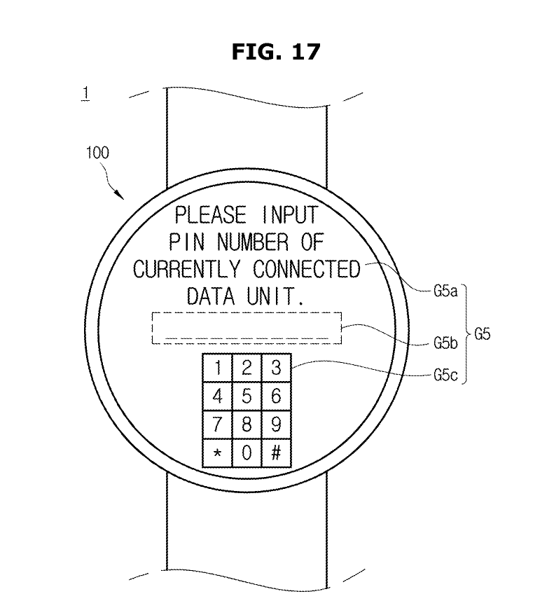

FIG. 17 illustrates a UI for receiving an input of a pin number when the newly connected data unit is connected to the main unit according to an exemplary embodiment.

When the data unit 200 connected to the main unit 100 is the new data unit 200 which has not been previously connected, it is necessary to perform authentication before the UI data stored in the data unit 200 is transferred to the main unit 100. Accordingly, the main unit 100 may provide a GUI G5 for authentication.

Specifically, the GUI G5 for the authentication may include pin number input guide text G5a, an input pin number display window G5b, and a pin number selection window G5c.

The pin number input guide text G5a may provide a message indicating that a pin number of the currently connected data unit 200 should be input to transfer the UI data stored in the new data unit 200 to the main unit 100. Specifically, the pin number input guide text G5a may provide text indicating “Would you like to input pin number of currently connected data unit?” on the touch screen 151.

The input pin number display window G5b may display the number of currently input pin numbers and the last input pin number. In addition, the input pin number display window G5b may be displayed as “*” for security of the previously input pin number excluding the last input pin number.

As the selection window for allowing the user to input the pin number, the user may input six characters of twelve characters to the pin number selection window G5c as illustrated in FIG. 17.

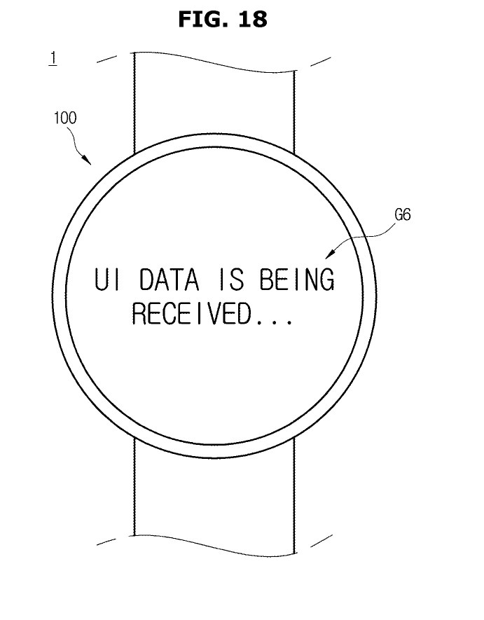

FIG. 18 illustrates a UI for displaying that UI data is transferred after an authentication procedure when the newly connected data unit is connected to the main unit according to an exemplary embodiment.

When the authentication procedure of the new data unit 200 as in FIG. 17 is completed, the UI data stored in the data unit 200 may be transferred to the main unit 100. In this case, the main unit 100 may provide the user with a message indicating that the UI data is being transferred. Specifically, the main unit 100 may provide the touch screen 151 with a GUI G6 including text indicating “UI data is being received.”

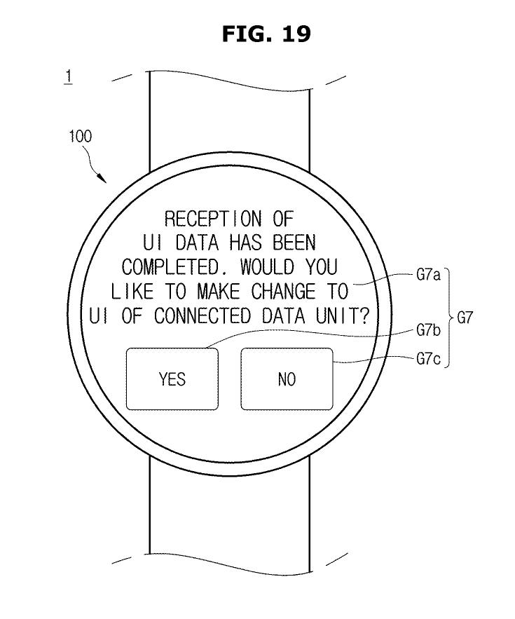

FIG. 19 illustrates a UI for receiving an input of whether to perform switching to interaction according to UI data transferred by the newly connected data unit according to an exemplary embodiment.

When the data unit 200 connected to the main unit 100 completely transfers UI data to the main unit 100, the main unit 100 may notify the user of the transfer completion and may provide a GUI G7 for receiving an input of whether to perform switching to interaction according to the transferred UI data.

In this case, the GUI G7 may include reception completion and interaction switching guide text G7a, an interaction switching selection window G7b, and an interaction non-switching selection window G7c.

The reception completion and interaction switching guide text G7a may provide a guide message indicating the completion of reception of UI data and whether to perform switching to interaction according to UI data for which the reception has been completed. Specifically, the main unit 100 may display text indicating “Reception of UI data has been completed. Would you like to make change to connected data unit?” on the touch screen 151.

The interaction switching selection window G7b and the interaction non-switching selection window G7c are windows for receiving a user command for whether to perform switching to the interaction according to UI data for which reception has been completed. Specifically, when the user desires to perform switching to the interaction according to UI data for which reception has been completed, he/she may press the interaction switching selection window G7b. In contrast, when the user does not desire to perform switching to the interaction according to UI data for which reception has been completed, he/she may press the interaction non-switching selection window G7c.

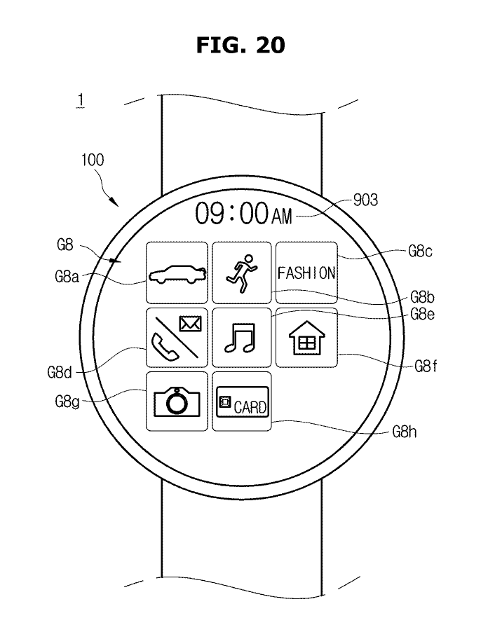

FIG. 20 illustrates a UI for selecting a type of interaction to be provided by a wearable device according to an exemplary embodiment.

The GUI G8 may be a screen for selecting a type of interaction capable of being switched according to the UI data currently stored in the main unit. The GUI G8 may include a time image 903, a vehicle UI selection key G8a, an exercise UI selection key G8b, a watch brand UI selection key G8c, a mobile terminal UI selection key G8d, an audio UI selection key G8e, a home appliance UI selection key G8f, a camera UI selection key G8g, and a payment UI selection key G8h.

The time image 903 may be an image for displaying time information of a region in which the wearable device 1 is currently located.

The vehicle UI selection key G8a may be a function key for receiving a user command for performing switching to the GUI for providing interaction for a vehicle based on UI data for the vehicle. The exercise UI selection key G8b may be a function key for receiving a user command for performing switching to the GUI for providing interaction for exercise based on UI data for the exercise. The watch brand UI selection key G8c may be a function key for receiving a user command for performing switching to the GUI for providing interaction for a watch brand based on UI data for the watch brand. The mobile terminal UI selection key G8d may be a function key for receiving a user command for performing switching to the GUI for providing interaction for a mobile terminal based on UI data for the mobile terminal. The audio UI selection key G8e may be a function key for receiving a user command for performing switching to the GUI for providing interaction for audio based on UI data for the audio. The home appliance UI selection key G8f may be a function key for receiving a user command for performing switching to the GUI for providing interaction for a home appliance based on UI data for the home appliance. The camera UI selection key G8g may be a function key for receiving a user command for performing switching to the GUI for providing interaction for a camera based on UI data for the camera. The payment UI selection key G8h may be a function key for receiving a user command for performing switching to the GUI for providing interaction for card payment based on UI data for the payment.

Hereinafter, an exemplary embodiment of the vehicle UI will be described with reference to FIGS. 21A to 21H.

After receiving at least one of pieces of UI data stored in the second memory 210, the main unit 100 may display a GUI for a specific vehicle.

For example, the UI for the specific vehicle is implemented, so that the user may check an external damage state of the vehicle and view an internal or external image at that time, and the damage notification for a target damaging an external portion of a vehicle may be provided by sounding an alarm in the vehicle.

In addition, the user may easily view a position of the vehicle in a parking garage, adjust an internal environment (for example, air, odor, a temperature, a vehicle seat, and the like) of the vehicle, and set a destination through a road guide program before getting into the vehicle.

In addition, the user may view an external state (for example, closing/opening of a door, ON/OFF of a light, a tire air pressure, the necessity of a vehicle wash, or the like) of the vehicle, and an internal state (for example, coolant, engine oil, washer liquid, whether oil is leaked, or whether a filter should be replaced) of the vehicle.

In addition, the user may view a currently refueled state of the vehicle, a charged state of a battery, a possible traveling distance, and the like, and the user may control start-up, a window, opening/closing of a top roof, opening/closing of a door, and opening/closing of a trunk when the wearable device 1 is used as a smartkey of the vehicle.

In addition, the user may view a position of the parking garage and use a convenient function such as a function of calling a substitute driver and the wearable device 1 may function as a toll collection system such as a Korean Hi-Pass system.

FIGS. 21A to 21H illustrate a vehicle UI for displaying a GUI on the main unit 100 using vehicle UI data.

FIG. 21A illustrates a first vehicle screen 910 of a vehicle UI.

The first vehicle screen 910 may be a main screen of the vehicle UI and may include a time image 903, a window position image 904, a window page image 905, a first vehicle function key (soft key) 911, a second vehicle function key 912, a third vehicle function key 913, a fourth vehicle function key 914, a fifth vehicle function key 915, a sixth vehicle function key 916, a seventh vehicle function key 917, an eighth vehicle function key 918, and a ninth vehicle function key 919.

The time image 903 may be an image for displaying time information of a region in which the wearable device 1 is currently located, the window position image 904 may be an image in which a position of a currently displayed window is expressed by filling a circle of a circular image corresponding to the position of the currently displayed window with color, and the window page image 905 may be an image in which the total number of windows and the number of pages of the currently displayed window are expressed by numerals.

The first vehicle function key 911 may be a function key for locking the door of the vehicle. The second vehicle function key 912 may be a function key for opening the door of the vehicle. The third vehicle function key 913 may be a function key for opening the trunk of the vehicle. The fourth vehicle function key 914 may be a function key for unlocking the trunk of the vehicle. The fifth vehicle function key 915 may be a function key for performing an operation of starting the vehicle. The sixth vehicle function key 916 may be a function key for performing operations of an air conditioner and a heater of the vehicle. The seventh vehicle function key 917 may be a function key for adjusting a seat of the vehicle. The eighth vehicle function key 918 may be a function key of controlling a direction of the vehicle. The ninth vehicle function key 919 may be a function key of opening the top roof in a convertible vehicle.

The first vehicle screen 910 illustrated in FIG. 21A may move to the next page according to finger motion from the right of the user to the left and move to the previous page according to finger motion from the left of the user to the right.

FIG. 21B illustrates the second vehicle screen 920 of the vehicle UI.

The second vehicle screen 920 may be a summary screen for the vehicle state and may include a summary state image.

Using the second vehicle screen 920, the user may view a schematic vehicle state without having to view detailed vehicle state screens one by one.

The summary state image may display a refueled state and a charged state of the vehicle, external damage of the vehicle, opening/closing of the trunk, ON/OFF of the light, and the like.

In addition, the second vehicle screen 920 illustrated in FIG. 21B may move to the next page according to finger motion from the right of the user to the left and move to the previous page according to finger motion from the left of the user to the right.

FIG. 21C illustrates the third vehicle screen 921 of the vehicle UI.

The third vehicle screen 921 may be a screen for displaying a refueled state of the vehicle and may include a time image 903, a window position image 904, a window page image 905, a refueled state image 923, a charged state image 922, and a possible traveling distance image 924.

Using the third vehicle screen 921, the user may view the current refueled state of the vehicle before getting into the vehicle and view a possible traveling distance.

The time image 903, the window position image 904, and the window page image 905 may be the same as or different from those described with reference to FIG. 21A.

The refueled state image 923 may be an image for displaying the refueled state of fuel with which the fuel tank is currently filled and may express a capacity of a fuel tank and a refueled amount expressed by a percentage and visually express a ratio thereof in the form of a round bar.

The charged state image 922 may be an image for displaying a current state of electric energy with which the battery is charged and may express a capacity of the battery and an amount of charge of electric energy by a percentage and visually express a ratio thereof in the form of a round bar.

The possible traveling distance image 924 may be an image for displaying a possible traveling distance of the vehicle based on a currently refueled state or an amount of charge of electric energy.

In addition, the third vehicle screen 921 of FIG. 21C may move to the next page according to finger motion from the right of the user to the left and move to the previous page according to finger motion from the left of the user to the right.

FIG. 21D illustrates the fourth vehicle screen 925 of the vehicle UI.

The fourth vehicle screen 925 may be a screen for displaying a vehicle position in a parking garage and may include a time image 903, a window position image 904, a window page image 905, vehicle parking position text 926, a parking garage image 927, a parking position image 928, and a user position image 929.

Using the fourth vehicle screen 925, the user may easily view the vehicle position in the parking garage.

The time image 903, the window position image 904, and the window page image 905 may be the same as or different from those described with reference to FIG. 21A.

The vehicle parking position text 926 may be an image for displaying a floor number and a parking sector of a parking garage in which the vehicle is currently parked, the parking garage image 927 may be an image for displaying a map of the parking garage of a floor number in which the vehicle is currently parked, the parking position image 928 may be an image for displaying a parking area in which the vehicle is currently parked in the parking garage image 927, and the user position image 929 may be an image for displaying a position at which the user is currently located.

In addition, the fourth vehicle screen 925 of FIG. 21D may move to the next page according to finger motion from the right of the user to the left and move to the previous page according to finger motion from the left of the user to the right.

FIG. 21E illustrates the fifth vehicle screen 930 of the vehicle UI.

The fifth vehicle screen 930 may be a screen for a road guide program of the vehicle and may include a time image 903, a window position image 904, a window page image 905, a road guide image 931, a destination setting prompt 932, a voice input function key 933, and a keyboard input function key 934.

Using the fifth vehicle screen 930, the user may set the road guide program before getting into the vehicle and depart for a destination without delay after getting into the vehicle.

The time image 903, the window position image 904, and the window page image 905 may be the same as or different from those described with reference to FIG. 21A.

The road guide image 931 may be an image for displaying the fact that a current value is a window for setting a destination in a road guide terminal in advance to the user. The destination setting prompt 932 may be an image for notifying the user of a command for setting a user-desired destination. The voice input function key 933 may be a function key for inputting the user-desired destination through voice recognition. The keyboard input function key 934 may be a function key for inputting the user-desired destination through a keyboard input.

In addition, the fifth vehicle screen 930 of FIG. 21E may move to the next page according to finger motion from the right of the user to the left and move to the previous page according to finger motion from the left of the user to the right.

FIG. 21F illustrates the sixth vehicle screen 935 of the vehicle UI.

The sixth vehicle screen 935 may be a screen for displaying an internal state of the vehicle and may include a time image 903, a window position image 904, a window page image 905, a coolant state image 935a, an engine oil state image 935b, a washer liquid state image 935c, an oil leak check image 935d, and a filter replacement check image 935e.

Using the sixth vehicle screen 935, the user may check an engine room state without opening a hood of the vehicle or reduce the loss of time necessary for checking an internal state through a vehicle display unit after getting into the vehicle.

The time image 903, the window position image 904, and the window page image 905 may be the same as or different from those described with reference to FIG. 21A.

As an image for displaying a capacity of coolant with which the coolant tank is currently filled, the coolant state image 935a may express a capacity of a coolant tank and a current coolant amount expressed by a percentage and visually express a ratio thereof in the form of a linear bar.

The engine oil state image 935b may be an image for displaying a capacity of engine oil with which the engine oil tank is currently filled and may express a capacity of an engine oil tank and a current engine oil amount expressed by a percentage and visually express a ratio thereof in the form of a linear bar.

The washer liquid state image 935c may be an image for displaying a capacity of a washer liquid with which the washer liquid tank is currently filled and may express a capacity of a washer liquid tank and a current washer liquid amount expressed by a percentage and visually express a ratio thereof in the form of a linear bar.

The oil leak check image 935d may be an image for displaying whether fuel, engine oil, or another liquid has leaked inside an engine room, and the filter replacement check image 935e may be an image for displaying whether an air cleaning filter or an air conditioning filter should be replaced.

In addition, the sixth vehicle screen 935 of FIG. 21F may move to the next page according to finger motion from the right of the user to the left and move to the previous page according to finger motion from the left of the user to the right.

FIG. 21G illustrates the seventh vehicle screen 940 of the vehicle UI.

The seventh vehicle screen 940 may be a screen for displaying an external state of the vehicle and may include a time image 903, a window position image 904, a window page image 905, a light state image 941, a door opening/closing check image 943, and a tire air pressure image 942.

Using the seventh vehicle screen 940, the user may view the external state of the vehicle without directly checking the vehicle.

The time image 903, the window position image 904, and the window page image 905 may be the same as or different from those described with reference to FIG. 21A.

The light state image 941 may be an image for displaying whether a light of the vehicle is turned on or off, and the door opening/closing check image 943 may be an image for displaying whether the vehicle is currently opened or closed.

The tire air pressure image 942 may be an image for displaying a current tire state to the user by displaying a tire air pressure of an individual wheel and may be divided into a left-front-tire air pressure image 942FL, a right-front-tire air pressure image 942FR, a left-rear-tire air pressure image 942RL, and a right-rear-tire air pressure image 942RR.

In addition, the seventh vehicle screen 940 of FIG. 21G may move to the next page according to finger motion from the right of the user to the left and move to the previous page according to finger motion from the left of the user to the right.

FIG. 21H illustrates the eighth vehicle screen 945 of the vehicle UI.

The eighth vehicle screen 945 may be a screen for displaying an external damage state of the vehicle and may include a time image 903, a window position image 904, a window page image 905, a vehicle damage prompt 946, a video function key 947, and an alarm function key 948.

Using the eighth vehicle screen 945, the user may easily detect an external damage state of the vehicle, that is, damage to an outer portion of the vehicle occurring in opening and closing the door of the adjacent vehicle such as a door dent and easily view a target damaging the vehicle.

The time image 903, the window position image 904, and the window page image 905 may be the same as or different from those described with reference to FIG. 21A.

The vehicle damage prompt 946 may be text indicating a time at which an outer portion of the vehicle has been damaged and whether there is damage. The video function key 947 may be a function key for displaying a video of an inside and outside of the vehicle immediately after/before the outer portion of the vehicle has been damaged. The alarm function key 948 may be a function key for causing a target damaging the vehicle to recognize the damage to the vehicle by generating an alarm of the vehicle.

In addition, the eighth vehicle screen 945 of FIG. 21H may move to the next page according to finger motion from the right of the user to the left and move to the previous page according to finger motion from the left of the user to the right.

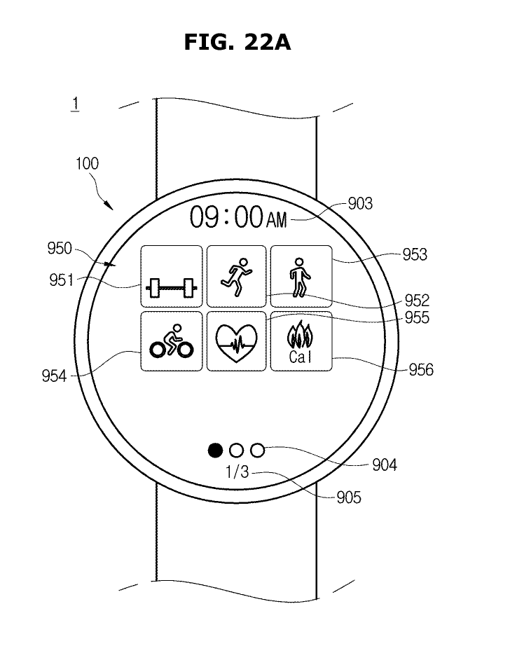

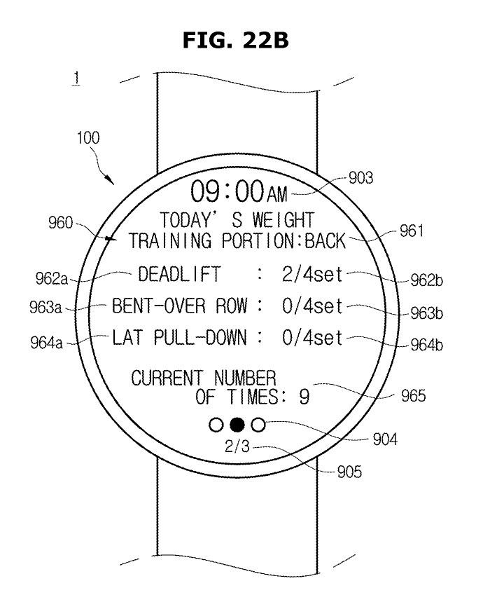

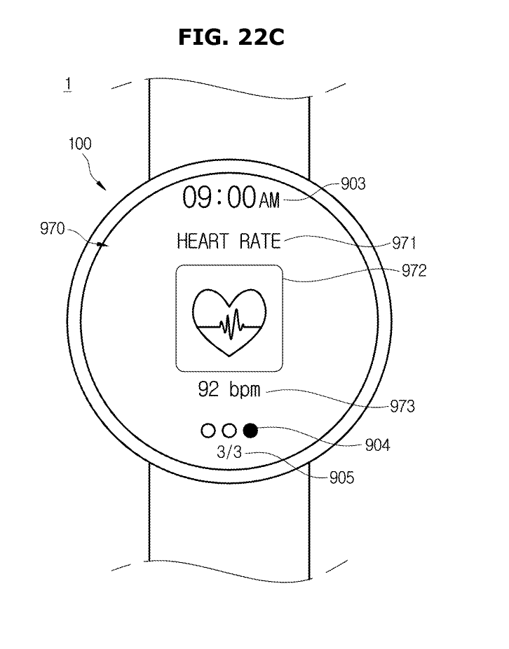

Hereinafter, an exemplary embodiment of an exercise UI will be described with reference to FIGS. 22A to 22C.

The main unit 100 may receive at least one of pieces of UI data stored in the second memory 210 and display a GUI for exercise.

For example, when the exercise UI is implemented, the user may view a movement distances and an average speed of working, running, or the like and check an instantaneous heart rate during the exercise and his/her body fat through in-body check before the exercise.

In addition, the user may recognize calories consumed by the exercise and calories to be eaten, schedule a diet, and check a store of sports goods.

In addition, the user may be coached according to an exercise coaching application or a schedule set by a trainer.

For example, when the user sets today's portion-specific weight training to perform the back exercise, deadlift, bent-over row, and lat pull-down are listed. In the case of chest exercise, bench press, dumbbell fly, and chest press are listed. In the case of lower body exercise, squat, leg press, and lunge are listed. In the case of shoulder exercise, overhead dumbbell press, dumbbell side lateral, and upright row are listed. In the case of bicep exercise, barbell curl, hammer curl, and cable curl are listed. In the case of triceps exercise, lying triceps extension, cable press down, and dumbbell kick back are list. The number of repetitions of each exercise and the number of exercise sets may be calculated.

In addition, the user may view a previous record for previous muscular exercise.

In addition, when the user performs weight training based on the heart rate, it may be possible to recognize a point in time at which maximum muscular strength is used to perform effective exercise.

FIGS. 22A to 22C illustrate an exercise UI for displaying a GUI on the main unit 100 using exercise UI data.

FIG. 22A illustrates a first exercise screen 950 of the exercise UI.

The first exercise screen 950 may be a main screen of the exercise UI and may include a time image 903, a window position image 904, a window page image 905, a first exercise function key 951, a second exercise function key 952, a third exercise function key 953, a fourth exercise function key 954, a fifth exercise function key 955, and a sixth exercise function key 956.

The time image 903 may be an image for displaying time information of a region in which the wearable device 1 is currently located, the window position image 904 may be an image in which a position of a currently displayed window is expressed by filling a circle of a circular image corresponding to the position of the currently displayed window with color, and the window page image 905 may be an image in which the total number of windows and the number of pages of the currently displayed window are expressed by numerals.

The first exercise function key 951 may be a function key for executing an application for weight training. The second exercise function key 952 may be a function key for executing an application for running. The third exercise function key 953 may be a function key for executing an application for walking. The fourth exercise function key 954 may be a function key for executing an application for a cycle. The fifth exercise function key 955 may be a function key for executing an application for a heart rate. The sixth exercise function key 956 may be a function key for executing an application for checking consumed calories.

In addition, the first exercise screen 950 illustrated in FIG. 22A may move to the next page according to finger motion from the right of the user to the left and move to the previous page according to finger motion from the left of the user to the right.

FIG. 22B illustrates a second exercise screen 960 of the exercise UI.

The second exercise screen 960 may be a screen for a weight training guide and may include a time image 903, a window position image 904, a window page image 905, a weight training portion image 961, a first exercise name image 962a, a first number-of-repetitions-of-exercise and number-of-exercise-sets image 962b, a second exercise name image 963a, a second number-of-repetitions-of-exercise and number-of-exercise-sets image 963b, a third exercise name image 964a, a third number-of-repetitions-of-exercise and number-of-exercise-sets image 964b, and a number-of-repetitions-of-current-exercise image 965.

Using the second exercise screen 960, the user may be coached on weight training and the accurate number of repetitions of exercise.

The time image 903, the window position image 904, and the window page image 905 may be the same as or different from those described with reference to FIG. 22A.

The weight training portion image 961 may be an image for a user-desired portion of weight training. In addition, the first exercise name image 962a may be an image for one exercise name for the corresponding portion. The first number-of-repetitions-of-exercise and number-of-exercise-sets image 962b may be an image for displaying the number of repetitions of first exercise and the number of sets of the first exercise. The second exercise name image 963a may be an image for another exercise name for the corresponding portion. The second number-of-repetitions-of-exercise and number-of-exercise-sets image 963b may be an image for displaying the number of repetitions of second exercise and the number of sets of the second exercise. The third exercise name image 964a may be an image for still another exercise name for the corresponding portion. The third number-of-repetitions-of-exercise and number-of-exercise-sets image 964b may be an image for displaying the number of repetitions of third exercise and the number of sets of the third exercise. The number-of-repetitions-of-current-exercise image 965 may be an image for displaying the number of repetition of current exercise.

In addition, the second exercise screen 960 illustrated in FIG. 22B may move to the next page according to finger motion from the right of the user to the left and move to the previous page according to finger motion from the left of the user to the right.

FIG. 22C illustrates a third exercise screen 970 of the exercise UI.

The third exercise screen 970 may be a screen for displaying a heart rate and may include a time image 903, a window position image 904, a window page image 905, a current window information image 971, a heart rate measurement icon 972, and a measured heart rate image 973.

Using the third exercise screen 970, the user may view an instantaneous heart rate during exercise.

The time image 903, the window position image 904, and the window page image 905 may be the same as or different from those described with reference to FIG. 22A.

The current window information image 971 may be an image for a notification indicating that a current window is a window for measuring a heart rate. The heart rate measurement icon 972 may be an image for visually expressing the window for measuring the heart rate. The measured heart rate image 973 may be an image for displaying a current instantaneous heart rate of the user detected through the biological detection sensor 510.

In addition, the third exercise screen 970 illustrated in FIG. 22C may move to the next page according to finger motion from the right of the user to the left and move to the previous page according to finger motion from the left of the user to the right.

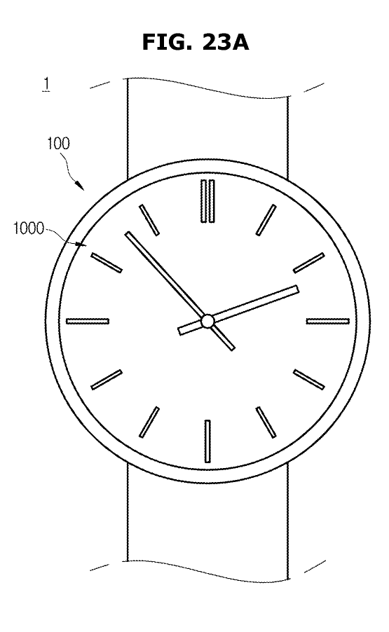

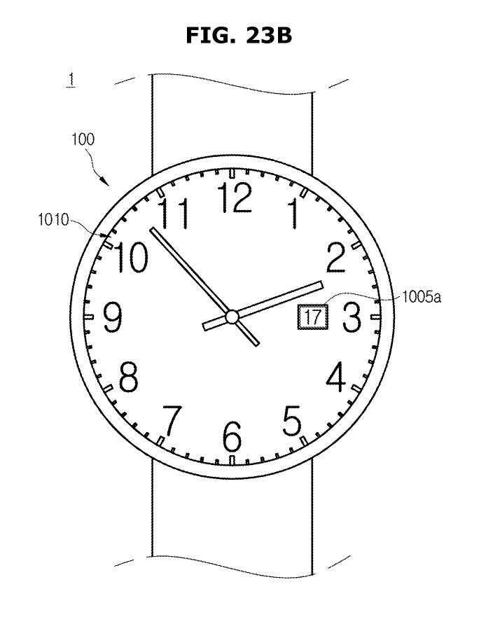

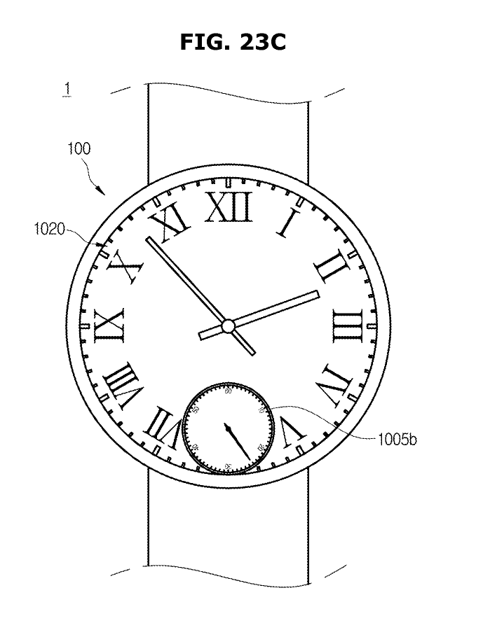

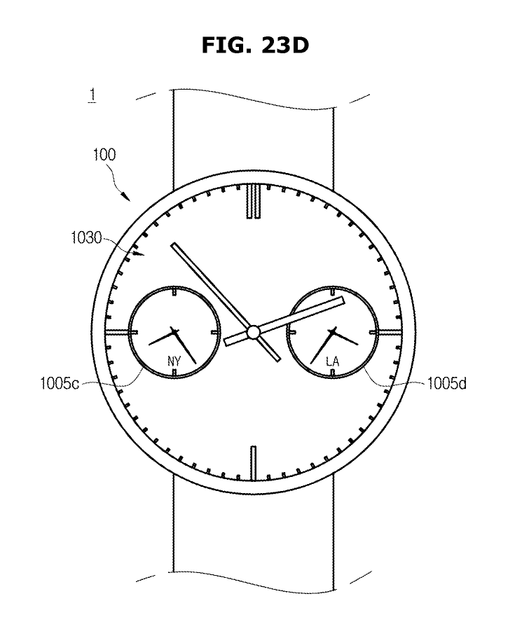

Hereinafter, an exemplary embodiment of a brand UI will be described with reference to FIGS. 23A to 23D.

The main unit 100 may receive at least one of pieces of UI data stored in the second memory 210 and display a GUI for a fashion.

For example, when a fashion UI is implemented, the user may make a change to a display designed in a specific brand and a watch design and display a logo of the specific brand.

In addition, the user may manage a possessed item of the specific brand and receive the recommendation of customized coordination.

In addition, the user may check a schedule of a reception or a fashion show to receive an invitation and issue information about family sales of the specific brand and discount coupons.

FIGS. 23A to 23D illustrate a watch brand UI for displaying a GUI on the main unit 100 using watch brand UI data.

A design and trademark of a specific brand may be displayed on the touch screen 151 of the main unit 100 according to UI data of a specific watch brand.

For example, as illustrated in FIGS. 23A and 23B, the touch screen 151 provides a time in the form of an analog watch. In addition, as illustrated in FIGS. 23C and 23D, the touch screen 151 may display a date and a world time by displaying at least one chronograph 1005 or function as a stop watch.

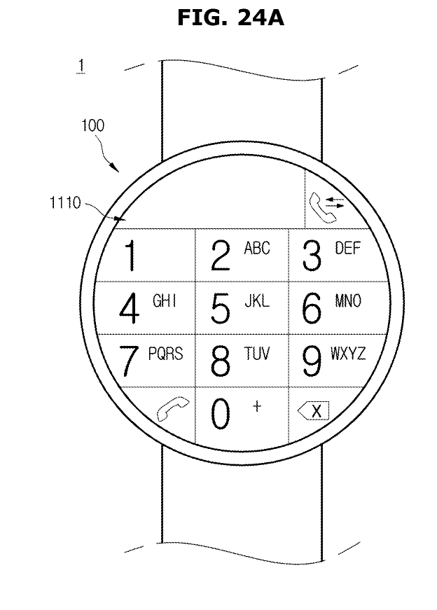

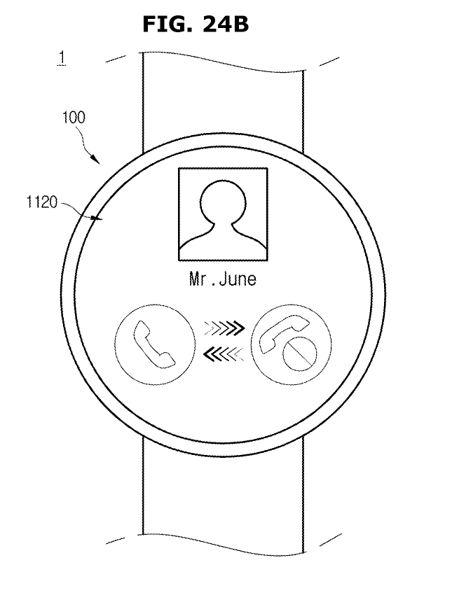

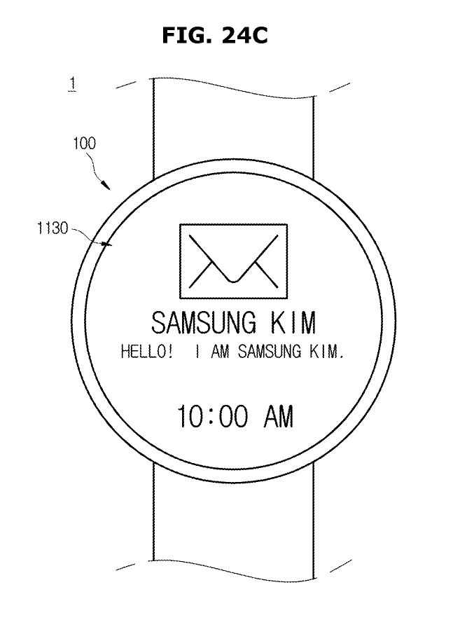

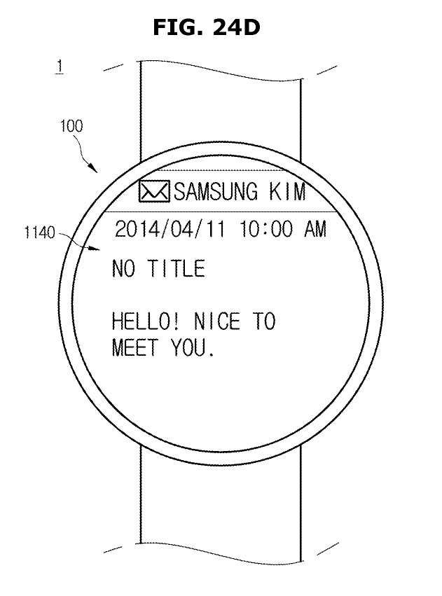

Hereinafter, an exemplary embodiment of a mobile terminal UI will be described with reference to FIGS. 24A to 24D.

The main unit 100 may receive at least one of pieces of UI data stored in the second memory 210 and display a GUI for a mobile terminal.

For example, through the GUI for the mobile terminal, the user may transmit and receive a short message and make a call. In this case, the wearable device 1 may also be linked to a mobile phone terminal manufactured by a company different from a manufacturer manufacturing the wearable device 1 or a mobile terminal using a different OS.

FIGS. 24A to 24D illustrate a mobile terminal UI for displaying a GUI on the main unit 100 using mobile terminal UI data.

FIG. 24A illustrates a first mobile terminal screen 1110 of a mobile terminal UI, FIG. 24B illustrates a second mobile terminal screen 1120 of the mobile terminal UI, FIG. 24C illustrates a third mobile terminal screen 1130 of the mobile terminal UI, and FIG. 24D illustrates a fourth mobile terminal screen 1140 of the mobile terminal UI.

The first mobile terminal screen 1110 provides a UI in which the user may make a phone call by operating a dial pad to input a phone number.

The second mobile terminal screen 1120 may display a prompt indicating that a phone call has been received in the wearable device 1 to notify the user of the phone call reception.

The third mobile terminal screen 1130 may display a prompt indicating that a text message has been received in the wearable device 1 to notify the user of the text message reception.

The fourth mobile terminal screen 1140 may provide detailed content of the received text message shown when the third mobile terminal screen 1130 is released.

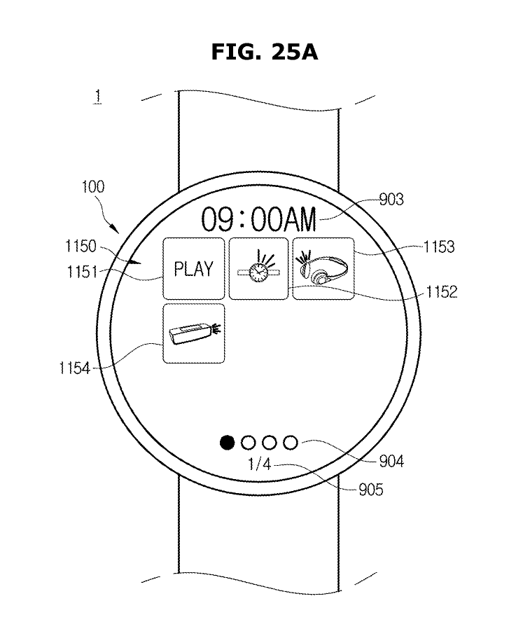

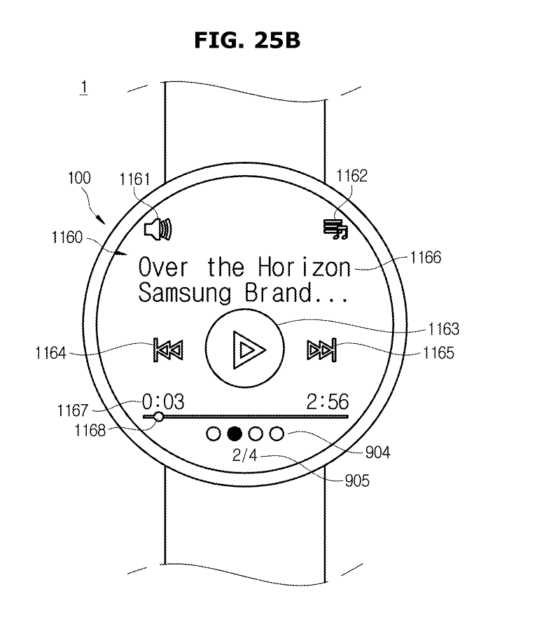

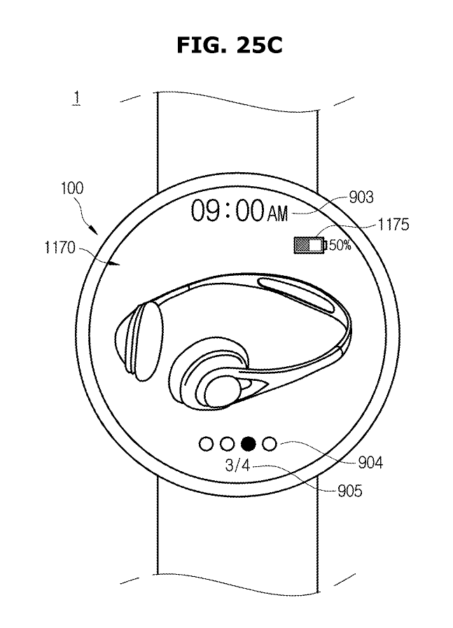

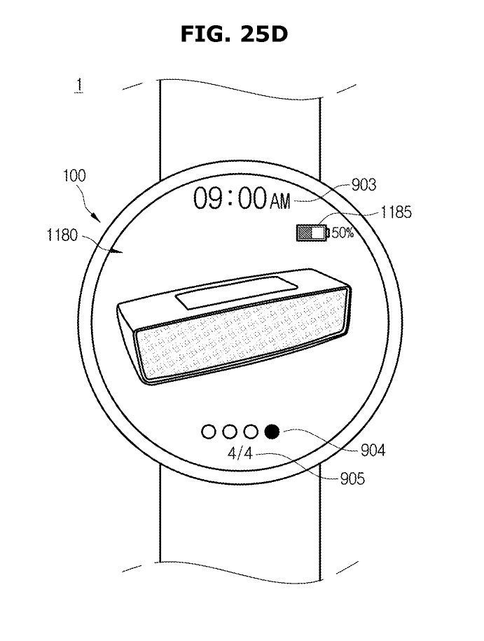

Hereinafter, an exemplary embodiment of an audio UI will be described with reference to FIGS. 25A to 25D.

The main unit 100 may receive at least one of pieces of UI data stored in the second memory 210 and display a GUI for audio.

For example, when the GUI for the audio is displayed, the user may control reproduction of music or moving images and change equalizer settings and a listening mode.

In addition, when a connection to at least one peripheral audio device is made, the user may control the peripheral audio device and view the remaining battery capacity of the peripheral audio device.

FIGS. 25A to 25D illustrate an audio UI for displaying a GUI on the main unit 100 using audio UI data.

FIG. 25A illustrates a first audio screen 1150 of an audio UI.

The first audio screen 1150 may be a main screen of the audio UI and may include a time image 903, a window position image 904, a window page image 905, a first audio function key 1151, a second audio function key 1152, a third audio function key 1153, and a fourth audio function key 1154.

The time image 903 may be an image for displaying time information of a region in which the wearable device 1 is currently located, the window position image 904 may be an image in which a position of a currently displayed window is expressed by filling a circle of a circular image corresponding to the position of the currently displayed window with color, and the window page image 905 may be an image in which the total number of windows and the number of pages of the currently displayed window are expressed by numerals.

The first audio function key 1151 may be a function key for executing a music play application. The second audio function key 1152 may be a function key for executing an application for controlling a speaker embedded in the wearable device 1. The third audio function key 1153 may be a function key for executing an application of an external headphone or an earphone. The fourth audio function key 1154 may be a function key for executing an application for an external speaker.

In addition, the first audio screen 1150 of FIG. 25A may move to the next page according to finger motion from the right of the user to the left and move to the previous page according to finger motion from the left of the user to the right.

FIG. 25B illustrates a second audio screen 1160 of the audio UI.

The second audio screen 1160 may be a screen of the audio UI and may include a window position image 904, a window page image 905, a volume adjustment function key 1161, a play list function key 1162, a play/pause function key 1163, a previous song function key 1164, a next song function key 1165, a title-of-song image 1166, a play time image 1167, and a play state image 1168.

Using the second audio screen 1160, the user may perform convenient control when music is reproduced.

The window position image 904 and the window page image 905 may be the same as or different from those described with reference to FIG. 25A.

The volume adjustment function key 1161 may be a function key for adjusting an audio volume when music is played. The play list function key 1162 may be a function key for displaying and editing a play list. The play/pause function key 1163 may be a function key for pausing music which is currently being played or playing music which is paused. The previous song function key 1164 may be a function key for returning to a previous song in the play list. The next song function key 1165 may be a function key for skipping to the next song in the play list. The title-of-song image 1166 may be an image for a title and a singer name of a song which is currently being played. The play time image 1167 may be an image for displaying a total play time and a current play time of a song which is currently being played. The play state image 1168 may be an image for displaying a position of the current play time to the total play time of the song which is currently being played through a linear bar.

In addition, the second audio screen 1160 of FIG. 25B may move to the next page according to finger motion from the right of the user to the left and move to the previous page according to finger motion from the left of the user to the right.

FIG. 25C illustrates a third audio screen 1170 of the audio UI.

The third audio screen 1170 may be a screen for control and states of the earphone and the headphone and may include a time image 903, a window position image 904, a window page image 905, and a remaining battery capacity image 1175.

Using the third audio screen 1170, the user may view the states of the earphone and the headphone to control the earphone and the headphone.

The time image 903, the window position image 904, and the window page image 905 may be the same as or different from those described with reference to FIG. 25A.

The remaining battery capacity image 1175 may be an image for displaying a capacity of a battery currently charged in the earphone or headphone.

In addition, the third audio screen 1170 of FIG. 25C may move to the next page according to finger motion from the right of the user to the left and move to the previous page according to finger motion from the left of the user to the right.

FIG. 25D illustrates a fourth audio screen 1180 of the audio UI.

The fourth audio screen 1180 may be a screen for control and a state of the speaker and may include a time image 903, a window position image 904, a window page image 905, and a remaining battery capacity image 1185.

Using the fourth audio screen 1180, the user may view the state of the speaker to control the speaker.

The time image 903, the window position image 904, and the window page image 905 may be the same as or different from those described with reference to FIG. 25A.

The remaining battery capacity image 1185 may be an image for displaying a capacity of a battery currently charged in the speaker.

In addition, the fourth audio screen 1180 of FIG. 25D may move to the next page according to finger motion from the right of the user to the left and move to the previous page according to finger motion from the left of the user to the right.

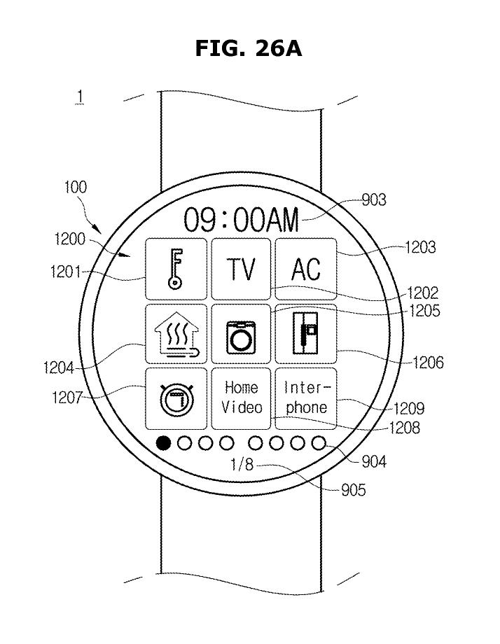

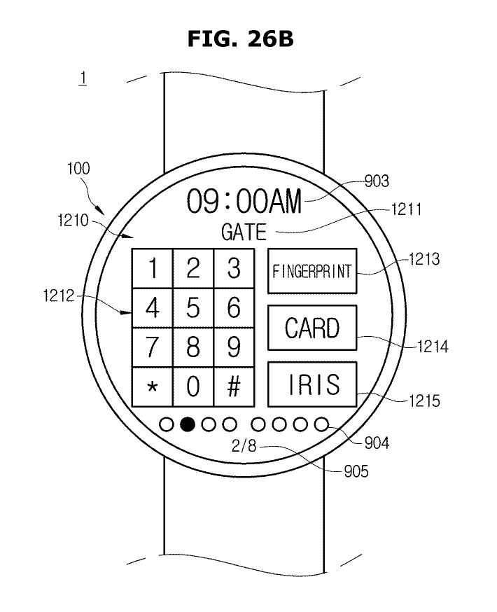

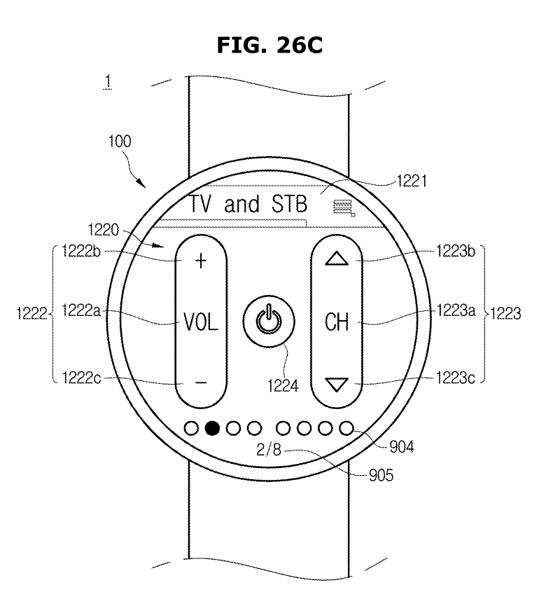

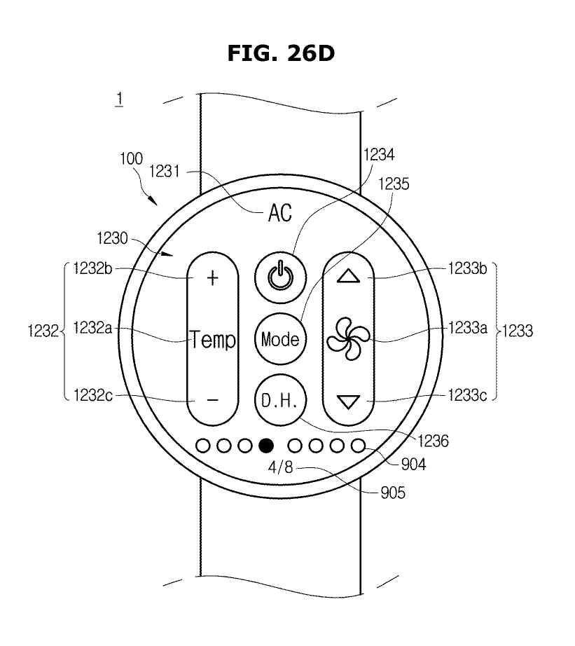

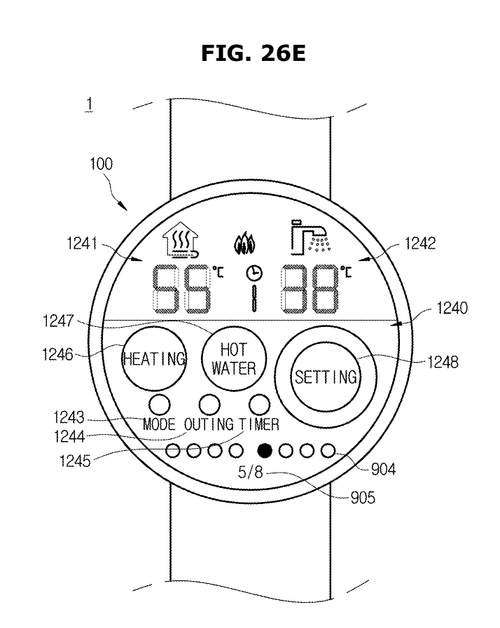

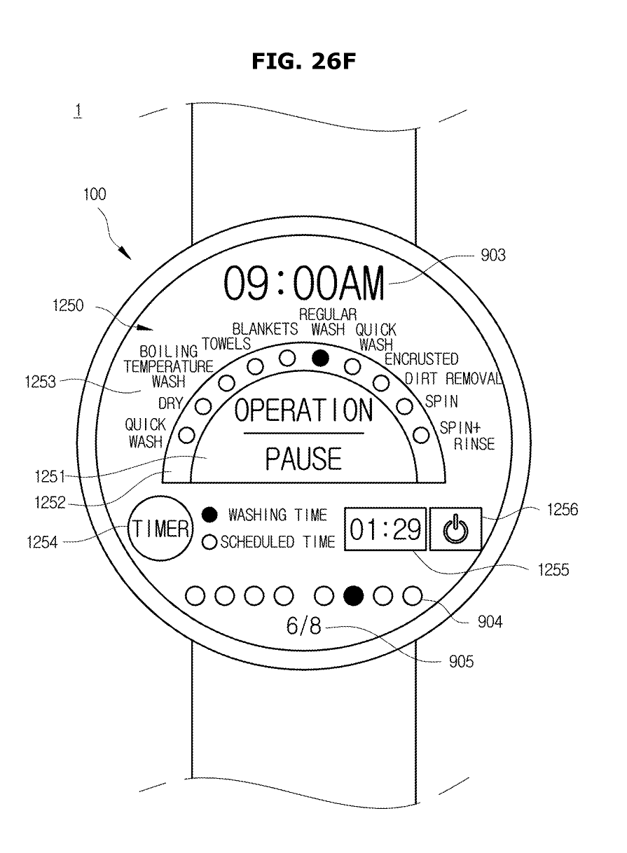

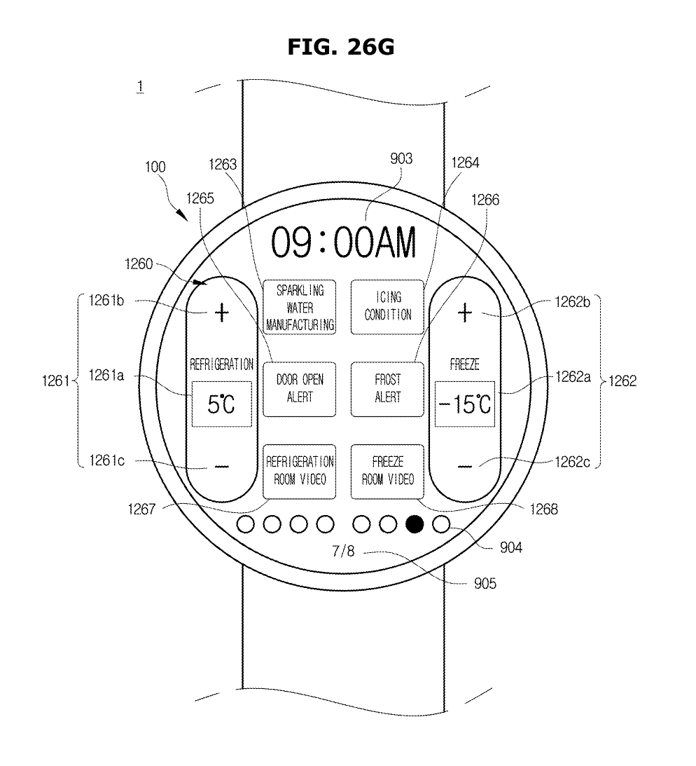

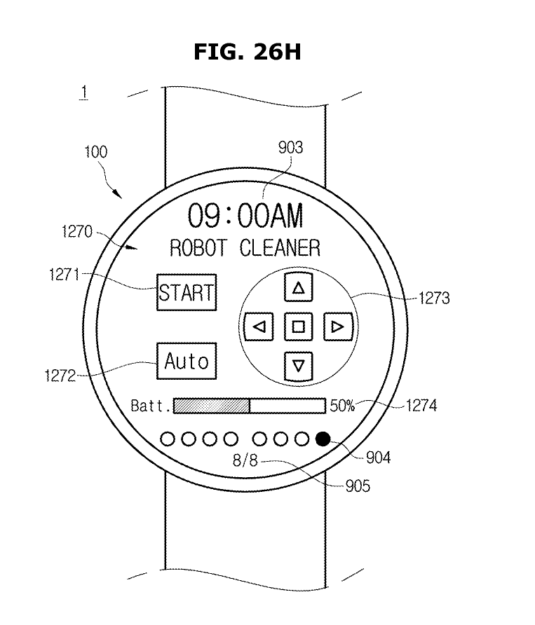

Hereinafter, an exemplary embodiment of a home appliance UI will be described with reference to FIGS. 26A to 26H.

The main unit 100 may receive at least one of pieces of UI data stored in the second memory 210 and display a GUI for a home appliance.

For example, the user may view and control the state of the home appliance at a position away from the home appliance through the home appliance UI and use the wearable device 1 serving as a remote controller without having to use the remote controller of each home appliance.

In addition, using the home appliance UI of the wearable device 1, the user may open and close a front door of the home before arrival to the front door, view the inside of the home, and communicate with a visitor.

FIGS. 26A to 26H illustrate a home appliance UI for displaying a GUI on the main unit 100 using home appliance UI data.

FIG. 26A illustrates a first home appliance screen 1200 of a home appliance UI.

The first home appliance screen 1200 may be a main screen of the home appliance UI and may include a time image 903, a window position image 904, a window page image 905, a first home appliance function key 1201, a second home appliance function key 1202, a third home appliance function key 1203, a fourth home appliance function key 1204, a fifth home appliance function key 1205, a sixth home appliance function key 1206, a seventh home appliance function key 1207, an eighth home appliance function key 1208, and a ninth home appliance function key 1209.

The time image 903 may be an image for displaying time information of a region in which the wearable device 1 is currently located, the window position image 904 may be an image in which a position of a currently displayed window is expressed by filling a circle of a circular image corresponding to the position of the currently displayed window with color, and the window page image 905 may be an image in which the total number of windows and the number of pages of the currently displayed window are expressed by numerals.

The first home appliance function key 1201 may be a function key for opening and closing a front door. The second home appliance function key 1202 may be a function key for controlling a television (TV) and viewing a state of the TV. The third home appliance function key 1203 may be a function key for controlling an air conditioner and viewing a state of the air conditioner. The fourth home appliance function key 1204 may be a function key for controlling a boiler and viewing a state of the boiler. The fifth home appliance function key 1205 may be a function key for controlling a washer and viewing a state of the washer. The sixth home appliance function key 1206 may be a function key for controlling a refrigerator and viewing a state of the refrigerator. The seventh home appliance function key 1207 may be a function key for controlling a robot cleaner and viewing a state of the robot cleaner. The eighth home appliance function key 1208 may be a function key for viewing a video of the inside of the home. The ninth home appliance function key 1209 may be a function key for contacting a visitor.

In addition, the first home appliance screen 1200 of FIG. 26A may move to the next page according to finger motion from the right of the user to the left and move to the previous page according to finger motion from the left of the user to the right.

FIG. 26B illustrates a second home appliance screen 1210 of a home appliance UI.

The second home appliance screen 1210 may be a screen for opening/closing of a front door and may include a time image 903, a window position image 904, a window page image 905, a selected home appliance name 1211, a password dial 1212, a fingerprint recognition function key 1213, a card recognition function key 1214, and an iris recognition function key 1215.

Using the second home appliance screen 1210, the user may open and close the front door before arriving at the front door.

The time image 903, the window position image 904, and the window page image 905 may be the same as or different from those described with reference to FIG. 26A.

The selected home appliance name 1211 may be text for displaying a name of the home appliance desired to be currently controlled. The password dial 1212 may be an input unit for inputting a password for opening and closing the front door. The fingerprint recognition function key 1213 may be a function key for opening and closing the door through fingerprint recognition of the user. The card recognition function key 1214 may be a function key for opening and closing the door through access card recognition of the front door. The iris recognition function key 1215 may be a function key for opening and closing the door through recognition of the user's iris.

In addition, the second home appliance screen 1210 illustrated in FIG. 26B may move to the next page according to finger motion from the right of the user to the left and move to the previous page according to finger motion from the left of the user to the right.

FIG. 26C illustrates a third home appliance screen 1220 of a home appliance UI.

The third home appliance screen 1220 may be a screen for the state and control of a TV and may include a window position image 904, a window page image 905, a selected home appliance name 1211, a power supply function key 1224, a volume adjustment function key 1222, and a channel adjustment function key 1223.

Using the third home appliance screen 1220, the user may control the TV without using a separate TV remote controller.

The window position image 904 and the window page image 905 may be the same as or different from those described with reference to FIG. 26A.

The selected home appliance name 1211 may be text for displaying a name of the home appliance to be currently controlled. The power supply function key 1224 may be a function key for turning on and off a power supply of the TV. The volume adjustment function key 1222 may be a function key for adjusting an audio volume of the TV. The channel adjustment function key 1223 may be a function key for adjusting a channel of the TV.

Specifically, the volume adjustment function key 1222 may include a volume image 1222a for displaying a target to be adjusted, a volume increase function key 1222b for increasing the audio volume of the TV, and a volume decrease function key 1222c for decreasing the audio volume of the TV. In addition, the channel adjustment function key 1223 may include a channel image 1223a for displaying a target to be adjusted, a channel increase function key 1223b for increasing a channel number of the TV, and a channel decrease function key 1223c for decreasing the channel number of the TV.

In addition, the third home appliance screen 1220 of FIG. 26C may move to the next page according to finger motion from the right of the user to the left and move to the previous page according to finger motion from the left of the user to the right.

FIG. 26D illustrates a fourth home appliance screen 1230 of a home appliance UI.

The fourth home appliance screen 1230 may be a screen for the state and control of an air conditioner and may include a window position image 904, a window page image 905, a selected home appliance name 1231, a power supply function key 1234, a mode adjustment function key 1235, a dehumidification setting function key 1236, a temperature adjustment function key 1232, and an air volume adjustment function key 1233.

Using the fourth home appliance screen 1230, the user may control the air conditioner without using a separate remote controller for the air conditioner.

The window position image 904 and the window page image 905 may be the same as or different from those described with reference to FIG. 26A.

The selected home appliance name 1231 may be text for displaying a name of a home appliance to be currently controlled. The power supply function key 1234 may be a function key for turning on and off the power supply of the air conditioner. The mode adjustment function key 1235 may be a function key for selecting an operation mode of the air conditioner. The dehumidification setting function key 1236 may be a function key for selecting a dehumidification operation. The temperature adjustment function key 1232 may be a function key for adjusting a desired temperature of the air conditioner. The air volume adjustment function key 1233 may be a function key for adjusting an air volume of the air conditioner.

Specifically, the temperature adjustment function key 1232 may include a temperature image 1232a for displaying a target desired to be adjusted, a temperature increase function key 1232b for increasing a desired temperature of the air conditioner, and a temperature decrease function key 1232c for decreasing the desired temperature of the air conditioner. In addition, the air volume adjustment function key 1233 may include an air volume image 1233a for displaying a target desired to be adjusted, an air volume increase function key 1233b for increasing the air volume of the air conditioner, and an air volume decrease function key 1233c for decreasing the air volume of the air conditioner.

In addition, the fourth home appliance screen 1230 of FIG. 26D may move to the next page according to finger motion from the right of the user to the left and move to the previous page according to finger motion from the left of the user to the right.

FIG. 26E illustrates a fifth home appliance screen 1240 of a home appliance UI.

The fifth home appliance screen 1240 may be a screen for the state and control of a boiler and may include a window position image 904, a window page image 905, a heating temperature image 1241, a water temperature image 1242, a mode state image 1243, an outing state image 1244, a timer setting state image 1245, a heating adjustment function key 1246, a hot water adjustment function key 1247, and a boiler setting function key 1248.

Using the fifth home appliance screen 1240, the user may view the state of the boiler in a remote place to control the boiler.

The window position image 904 and the window page image 905 may be the same as or different from those described with reference to FIG. 26A.

The heating temperature image 1241 may be an image for displaying a user-desired heating temperature. The water temperature image 1242 may be an image for displaying a user-desired water temperature. The mode state image 1243 may be an image for displaying a currently set mode of the boiler. The outing state image 1244 may be an image for displaying whether the state has currently transitioned to the outing state. The timer setting state image 1245 may be an image for displaying a current timer setting state. In addition, the heating adjustment function key 1246 may be a function key for adjusting a desired heating temperature. The hot water adjustment function key 1247 may be a function key for adjusting a desired water temperature. The boiler setting function key 1248 may be a function key for changing the setting of the boiler.

In addition, the fifth home appliance screen 1240 of FIG. 26E may move to the next page according to finger motion from the right of the user to the left and move to the previous page according to finger motion from the left of the user to the right.

FIG. 26F illustrates a sixth home appliance screen 1250 of a home appliance UI.

The sixth home appliance screen 1250 may be a screen for the state and control of a washer and may include a time image 903, a window position image 904, a window page image 905, an operation/pause function key 1251, a wash course menu image 1253, a wash course selection image 1252, a power supply function key 1256, a timer function key 1254, and a timer image 1255.

Using the sixth home appliance screen 1250, the user may view the state of the washer in a remote place and control the washer.

The time image 903, the window position image 904, and the window page image 905 may be the same as or different from those described with reference to FIG. 26A.

The operation/pause function key 1251 may be a function key for starting and stopping the selected wash course, the wash course menu image 1253 may be a function key for displaying a type of wash course to be performed by the washer to the user. The wash course selection image 1252 may be an image for displaying a wash course selected by the user during the wash course. The power supply function key 1256 may be a function key for turning on/off the power supply of the washer. The timer function key 1254 may be a function key for setting a timer function of the washer. The timer image 1255 may be an image for displaying a required wash time, the remaining time, a scheduled time, and the like.

In addition, the sixth home appliance screen 1250 of FIG. 26F may move to the next page according to finger motion from the right of the user to the left and move to the previous page according to finger motion from the left of the user to the right.

FIG. 26G illustrates a seventh home appliance screen 1260 of a home appliance UI.

The seventh home appliance screen 1260 may be a screen for the state and control of a refrigerator and may include a time image 903, a window position image 904, a window page image 905, a sparkling water manufacturing function key 1263, an icing condition check function key 1264, a door open alert image 1265, a frost alert image 1266, a refrigeration room video function key 1267, a freeze room video function key 1268, a refrigeration temperature adjustment function key 1261, and a freeze temperature adjustment function key 1262.

Using the seventh home appliance screen 1260, the user may view the state of the refrigerator in a remote place to control the refrigerator.

The time image 903, the window position image 904, and the window page image 905 may be the same as or different from those described with reference to FIG. 26A.

The sparkling water manufacturing function key 1263 may be a function key for controlling sparkling water manufacturing. The icing condition check function key 1264 may be a function key for viewing a state of an ice generated in the refrigerator. The door open alert image 1265 may be an image for displaying whether the door of the refrigerator has been appropriately closed. The frost alert image 1266 may be an image for displaying whether the frost has been generated inside the refrigerator. The refrigeration room video function key 1267 may be a function key for displaying a current internal video of the refrigeration room. The freeze room video function key 1268 may be a function key for displaying a current internal vide of the freeze room. The refrigeration temperature adjustment function key 1261 may be a function key for adjusting a desired temperature of the refrigeration room. The freeze temperature adjustment function key 1262 may be a function key for adjusting a desired temperature of the freeze room.

Specifically, the refrigeration temperature adjustment function key 1261 may include a refrigeration temperature image 1261a for displaying a current temperature and a desired refrigeration temperature of the refrigeration room, a refrigeration temperature increase function key 1261b for increasing a desired temperature of the refrigeration room, and a refrigeration temperature decrease function key 1261c for decreasing the desired temperature of the refrigeration room. In addition, the freeze temperature adjustment function key 1262 may include a freeze temperature image 1262a for displaying a current temperature and a desired freeze temperature of the freeze room, a freeze temperature increase function key 1262b for increasing a desired temperature of the freeze room, and a freeze temperature decrease function key 1262c for decreasing the desired temperature of the freeze room.

In addition, the seventh home appliance screen 1260 of FIG. 26G may move to the next page according to finger motion from the right of the user to the left and move to the previous page according to finger motion from the left of the user to the right.

FIG. 26H illustrates an eighth home appliance screen 1270 of a home appliance UI.

The eighth home appliance screen 1270 may be a screen for the state and control of a robot cleaner and may include a time image 903, a window position image 904, a window page image 905, a start function key 1271, an automatic driving function key 1272, a direction adjustment function key 1273, and a battery state image 1274.

Using the eighth home appliance screen 1270, the user may control the robot cleaner without using a remote controller of the robot cleaner and view the state of the robot cleaner.

The time image 903, the window position image 904, and the window page image 905 may be the same as or different from those described with reference to FIG. 26A.

The start function key 1271 may be a function key for starting an operation of the robot cleaner. The automatic driving function key 1272 may be a function key for an input for enabling the robot cleaner to perform cleaning without control of the user. The direction adjustment function key 1273 may be a function key for enabling the user to manually operate an operation of the robot cleaner. The battery state image 1274 may be an image for displaying a current battery charged state of the robot cleaner.

In addition, the eighth home appliance screen 1270 of FIG. 26H may move to the next page according to finger motion from the right of the user to the left and move to the previous page according to finger motion from the left of the user to the right.

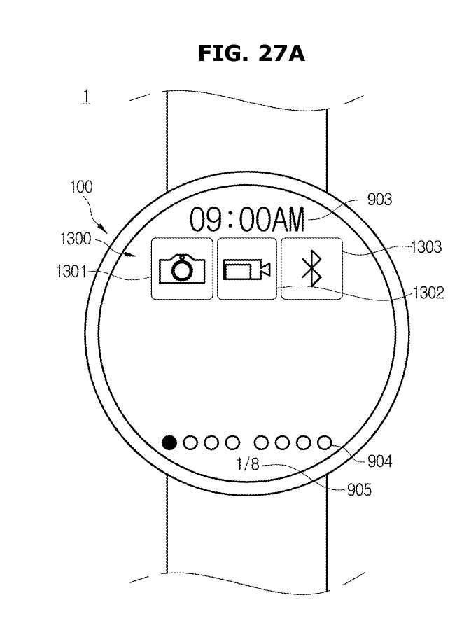

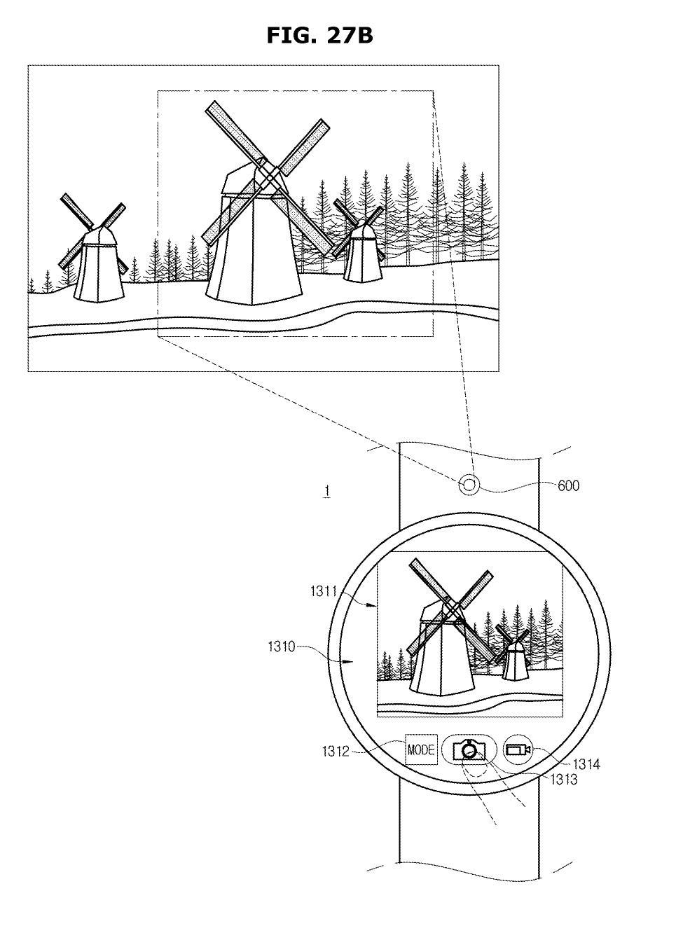

Hereinafter, an exemplary embodiment of a camera UI will be described with reference to FIGS. 27A and 27B.

The main unit 100 may receive at least one of pieces of UI data stored in the second memory 210 and display a GUI for a camera.

For example, when a camera UI is implemented, the user may capture an image using a camera provided in the fixing unit 300 or the main unit 100, control an external device by making a connection to the external device, and store and transmit the captured image.

FIGS. 27A and 27B illustrate a camera UI for displaying a GUI on the main unit 100 using camera UI data.

FIG. 27A illustrates a first camera screen 1300 of a camera UI.

The first camera screen 1300 may be a main screen for the camera UI and may include a time image 903, a window position image 904, a window page image 905, a first camera function key 1301, a second camera function key 1302, and a third camera function key 1303.

The time image 903 may be an image for displaying time information of a region in which the wearable device 1 is currently located, the window position image 904 may be an image in which a position of a currently displayed window is expressed by filling a circle of a circular image corresponding to the position of the currently displayed window with color, and the window page image 905 may be an image in which the total number of windows and the number of pages of the currently displayed window are expressed by numerals.

The first camera function key 1301 may be a function key for executing an application for capturing a still image using the camera embedded in the wearable device 1, the second camera function key 1302 may be a function key for executing an application for capturing a moving image using the camera embedded in the wearable device 1, and the third camera function key 1303 may be a function key for executing an application for another camera connected to the wearable device 1.

In addition, the first camera screen 1300 of FIG. 27A may move to the next page according to finger motion from the right of the user to the left and move to the previous page according to finger motion from the left of the user to the right.

FIG. 27B illustrates a second camera screen 1310 of a camera UI.

The second camera screen 1310 may be a screen for a still image and a moving image of the camera and may include an image capturing mode function key 1312, a still-image capturing function key 1313, a moving-image capturing function key 1314, and a captured still image 1311.

Using the second camera screen 1310, the user may capture an image using an internally embedded camera or an external camera.

The image capturing mode function key 1312 may be a function key for selecting an image capturing mode. The still-image capturing function key 1313 may be a function key for capturing an image displayed on a current screen. The moving-image capturing function key 1314 may be a function key for transition to a moving-image capturing mode. The captured still image 1311 may be an image for displaying a still image to be captured through a camera lens.

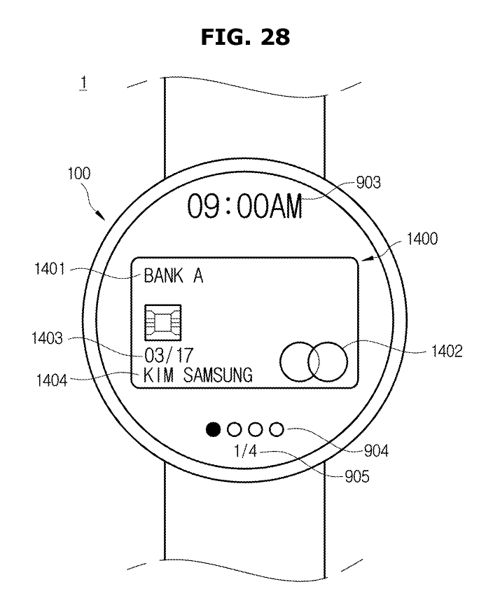

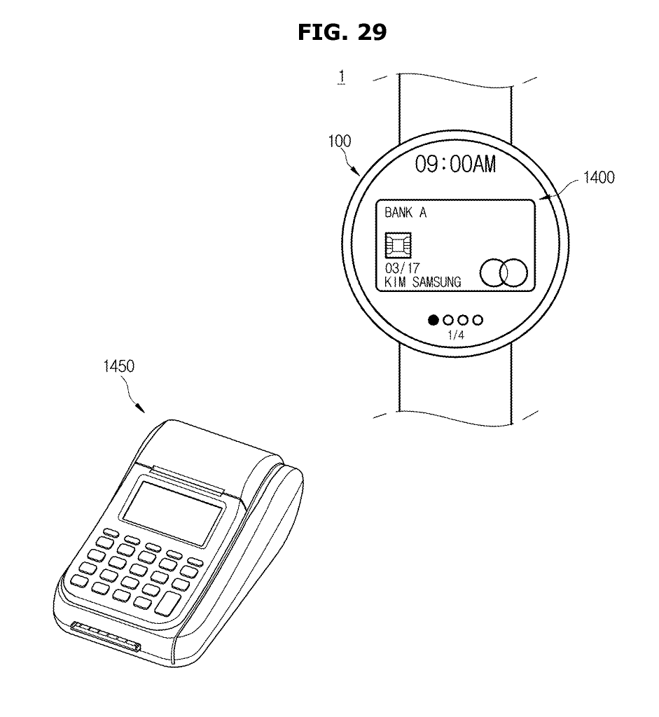

FIGS. 28 to 29 illustrate a payment UI for displaying a GUI on the main unit 100 using payment UI data.

FIG. 28 illustrates a GUI for card payment.

The GUI 1400 for the card payment may include a time image 903, a window position image 904, a window page image 905, a first card payment function key 1401, a second card payment function key 1402, a third card payment function key 1403, and a fourth card payment function key 1404.

The time image 903 may be an image for displaying time information of a region in which the wearable device 1 is currently located, the window position image 904 may be an image in which a position of a currently displayed window is expressed by filling a circle of a circular image corresponding to the position of the currently displayed window with color, and the window page image 905 may be an image in which the total number of windows and the number of pages of the currently displayed window are expressed by numerals.

The first card payment function key 1401 may be used to display information about a national card company. The second card payment function key 1402 may be used to display an overseas card company. The third card payment function key 1403 may be used to display a valid period of the selected card. The fourth card payment function key 1404 may be used to display a name of an owner of the selected card.

FIG. 29 illustrates a concept in which the user uses a payment UI according to an exemplary embodiment.

As illustrated in FIG. 29, when the user selects a card to be used and holds the selected card in the vicinity of a card terminal 1450, the payment module of the wearable device 1 may transfer an NFC radio signal to the card terminal 1450 to pay an amount of money to be paid.

In addition, when the user selects a card to be used and holds the selected card in the vicinity of the card terminal 1450, the payment module of the wearable device 1 may transfer an MST radio signal to the card terminal 1450 to pay an amount of money to be paid. Specifically, it is possible to transfer the same magnetic field as that of a magnetic signal generated from swiping the backside of an actual card to the card terminal 1450 and cause a card to be used to be recognized for payment.

Hereinafter, although not illustrated in the drawing, an example of a UI to be implemented using UI data will be described.

The main unit 100 may receive at least one of pieces of UI data stored in the second memory 210 and display a medical GUI.

For example, when the medical UI is implemented, the user may find the disease by checking a blood pressure, blood sugar, inflammation, and another body state through the biological detection sensor 510 and may be diagnosed for a treatment method.

In addition, the user may receive the guide of a hospital and a drugstore related to the corresponding diagnosed disease, call an emergency car to a position at which there is a user wearing the wearable device 1 using a position detection sensor, to notify others of an emergency state when the emergency state is determined based on a biological signal of the user.

In addition, the main unit 100 may receive at least one of pieces of UI data stored in the second memory 210 and display a GUI for a performance.

For example, when a performance UI is implemented, the user may receive a movie preview ticket and a discount coupon of the corresponding performance and check a performance of an overseas celebrity in Korea and a festival schedule.

In addition, the user may use the wearable device 1 as a support tool by displaying support text on the touch screen 151 of the wearable device 1.

In addition, the main unit 100 may receive at least one of pieces of UI data stored in the second memory 210 and display a GUI for travel.

For example, when the travel UI is implemented, the user may acquire information about a world time, a time difference of a corresponding destination, a flight time, a departure time of an airplane, and accommodations, famous restaurants, weather forecasts, traffic information, currency exchange, featured products, and attractions of the corresponding destination.

In addition, the user may easily recognize a rough map of a transfer airport and a boarding gate and receive a road guide to the boarding gate.

In addition, the main unit 100 may receive at least one of pieces of UI data stored in the second memory 210 and display a GUI for traffic.

For example, when the traffic UI is implemented, the user may acquire information about public transportation to the destination, a car dispatching time, and the remaining time and the user may use the wearable device 1 for a traffic fee payment.

In addition, the main unit 100 may receive at least one of pieces of UI data stored in the second memory 210 and display a GUI for leisure.

For example, if the leisure UI is implemented, the user may receive a trail guide and a compass guide in the case of climbing and acquire information about a shelter.

In addition, when the user plays golf, he/she may acquire information about drive, wood, and iron distances, a wind direction of a current round hole, the remaining distance, a slope, and a height, acquire information about the number of strokes, and receive the support of caddying.

In addition, when the user is skiing or snowboarding, he/she may acquire information about weather and slope states of a current ski resort and a waiting time of each ski lift.

In addition, the main unit 100 may receive at least one of pieces of UI data stored in the second memory 210 and display a GUI for a 3D printer.

For example, when a UI for a 3D printer is implemented, the user may view a 3D drawing to be printed, acquire information about a progress state, a required time, and the remaining time of current printing, and receive the notice of supplement for an insufficient material.

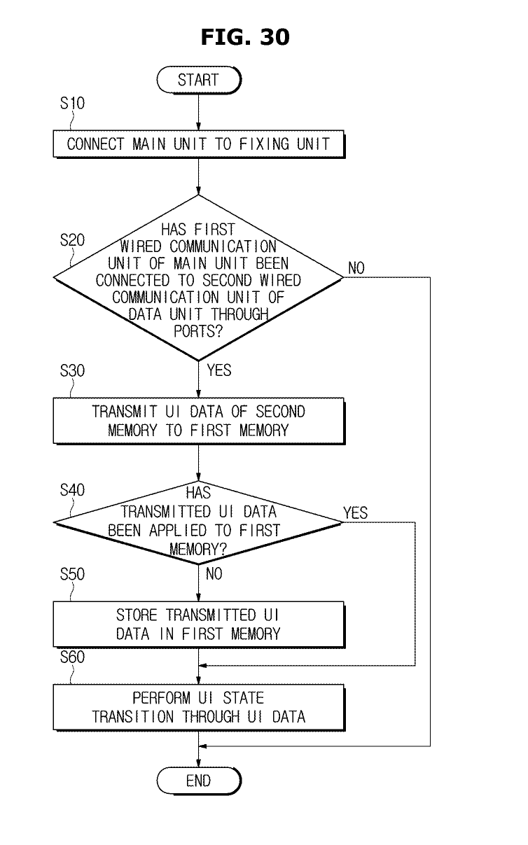

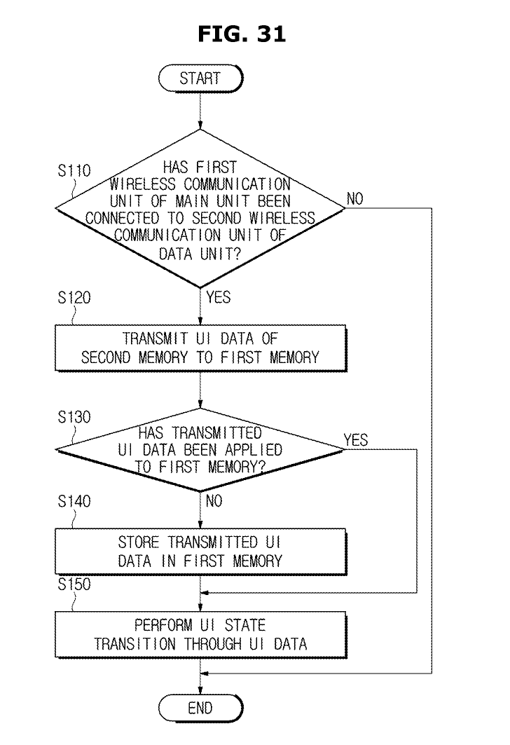

Hereinafter, an exemplary embodiment of a method of transmitting UI data and displaying a GUI will be described with reference to FIGS. 30 and 31.

FIG. 30 is a flowchart illustrating a method in which the main unit receives UI data through wired communication and displays a GUI.

First, a first communication port and a second communication port are connected by connecting the main unit and the fixing unit (operation S10), and the first wired communication unit and the second wired communication unit determine whether the first wired communication unit of the main unit has been connected to the second wired communication unit of the data unit through ports (operation S20).

When the first communication port is not connected to the second communication port, the wearable device ends the UI data transfer and the UI state transition.

In contrast, when it is determined that the first communication port is connected to the second communication port, the first wired communication unit and the second wired communication unit transmit at least one of pieces of UI data stored in the second memory to the first memory (operation S30).

Also, the control unit checks whether the transmitted UI data is stored in the first memory (operation S40).

When the transmitted UI data is stored in the first memory, the main unit causes the UI state to transition using the UI data stored in the first memory (operation S60).

In contrast, when the transmitted UI data is not stored in the first memory, the first memory stores the transmitted UI data (operation S50) and the main unit causes the UI state to transition using the UI data stored in the first memory (operation S60).

FIG. 31 is a flowchart illustrating a method in which the main unit receives UI data through wireless communication and displays a GUI.

First, the first wireless communication unit and the second wireless communication unit determine whether the first wireless communication unit of the main unit and the second wireless communication unit of the data unit are connected through a radio session (operation S110).

When it is determined that the first wireless communication unit and the second wireless communication unit are not connected through the radio session, the wearable device ends the UI data transfer and the UI state transition.

In contrast, when it is determined that the first wireless communication unit and the second wireless communication unit are connected through the radio session, the first wireless communication unit and the second wireless communication unit transmit at least one of pieces of UI data to the first memory (operation S120).

Then, the control unit checks whether the transmitted UI data is stored in the first memory (operation S130).

When the transmitted UI data is stored in the first memory, the main unit causes the UI state to transition using the UI data stored in the first memory (operation S150).

In contrast, when the transmitted UI data is not stored in the first memory, the first memory stores the transmitted UI data (operation S140) and the main unit causes the UI state to transition using the UI data stored in the first memory (operation S150).

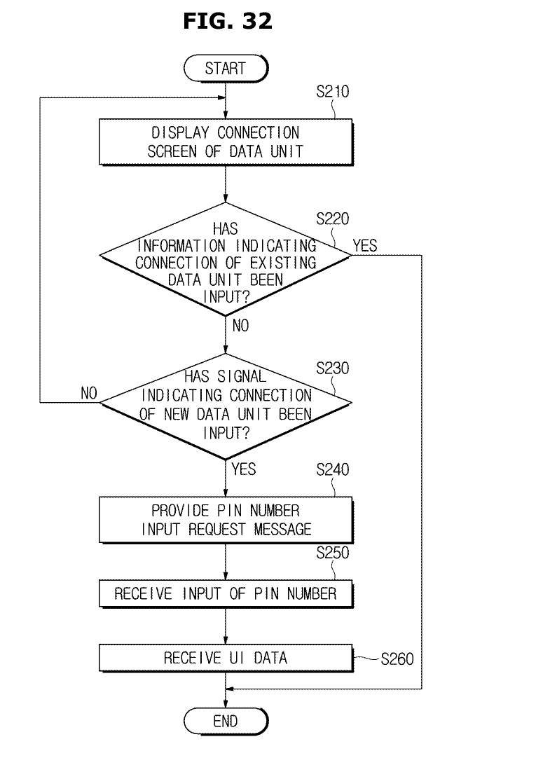

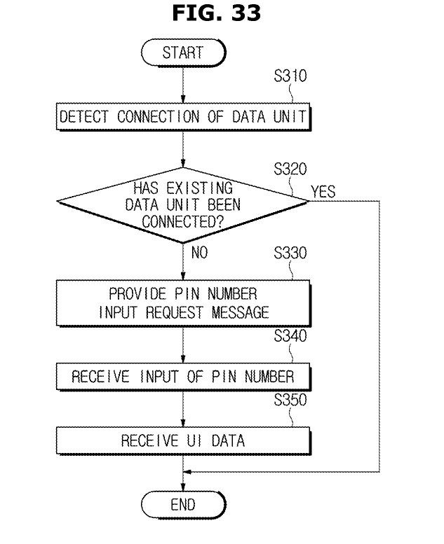

Hereinafter, exemplary embodiments of a method of determining whether the data unit currently connected to the main unit is a previously connected data unit or a newly connected data unit and performing authentication when the data unit is the newly connected data unit will be described with reference to FIGS. 32 and 33.

FIG. 32 is a flowchart illustrating a method of connecting the main unit to the data unit after an input of whether the data unit is the previously connected data unit or the newly connected data unit is received manually.

First, when the connection of the data unit to the main unit is recognized or input, the main unit may display a connection screen of the data unit on the touch screen (operation S210).

Then, the main unit may determine whether a user signal indicating that the existing data unit has currently been connected to the main unit has been received (operation S220).

When the main unit determines that the user signal indicating that the existing data unit has currently been connected to the main unit has been received, the main unit may immediately end the process without performing an authentication procedure and the UI data transmission process.

In contrast, when the main unit determines that the user signal indicating that the existing data unit has currently been connected to the main unit has not been received, the main unit may determine whether the user signal indicating that the new data unit has currently been connected to the main unit has been received (operation S230).

When the main unit determines that the user signal indicating that the new data unit has currently been connected to the main unit has not been received, the main unit may perform operations S210 to S230 again.

In contrast, when the main unit determines that the user signal indicating that the new data unit has currently been connected to the main unit has been received, the main unit may provide a request message for inputting a pin number of the currently connected data unit to the touch screen (operation S240).

Then, when the main unit receives the pin number input from the user (operation S250), the authentication procedure may end. Thereafter, the main unit may receive and store UI data stored in the data unit (operation S260).

FIG. 33 is a flowchart illustrating a method of automatically detecting and determining whether the data unit is the previously connected data unit or the newly connected data unit and connecting the main unit to the data unit.

First, the main unit may detect that the data unit has been connected (operation S310).

Then, the main unit may determine whether the currently connected data unit is the previously connected data unit (operation S320).

When the main unit may determine that the currently connected data unit is the previously connected data unit, the main unit may end the process without performing an authentication procedure and the UI data transmission process.

In contrast, when the main unit determines that the existing data unit has not been connected to the main unit, the main unit may provide a request message for inputting a pin number of the currently connected data unit to the touch screen (operation S330).

Then, when the main unit receives the pin number input from the user (operation S340), the authentication procedure may end. Thereafter, the main unit may receive and store UI data stored in the data unit (operation S350).

As is apparent from the above description, according to a wearable device and a control method of the wearable device, it is possible to download and execute an application or the like through communication with a fixing unit corresponding to each thing without individually downloading the application for each thing through a central server.

As described above, the present disclosure has been described merely in connection with the exemplary embodiments, and the skilled in this art can make modifications, variations and substitution without departing from the essential scope of the present disclosure. Accordingly, the exemplary embodiments and the drawing of this disclosure do not intend to limit but to explain the technical idea of this disclosure, and the scope of the technical idea of this disclosure is not limited to the embodiments and the drawings. The protection scope of the present disclosure should be interpreted with claims appended, and all technical ideas within equivalent scope with this disclosure should be in the protection scope of this disclosure.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A wearable device comprising:
a main unit configured to provide an interaction with at least one of a user of the wearable device and an external device; and
a replaceable fixing unit configured to transfer user interface (UI) data to the main unit and to provide a fixing force to fix the replaceable fixing unit to the user when the wearable device is worn by the user,
wherein the main unit is configured to provide the interaction based on the transferred UI data.

2. The wearable device according to claim 1, wherein the main unit is configured to switch to the interaction based on the transferred UI data when the transferred UI data is received by the main unit.

3. The wearable device according to claim 1, wherein the interaction includes displaying, by the main unit, a graphical user interface (GUI) based on the transferred UI data.

4. The wearable device according to claim 1, wherein the main unit includes
a memory configured to store current transferred UI data and previous transferred UI data.

5. The wearable device according to claim 4, wherein the main unit provides the interaction based on at least one of the current transferred UI data and the previous transferred UI data.

6. The wearable device according to claim 1, wherein the main unit receives UI data from the external device to provide the interaction based on the received UI data.

7. The wearable device according to claim 1, further comprising:
a power supply unit provided in the fixing unit and configured to supply power to the wearable device.

8. The wearable device according to claim 1, further comprising:
a camera provided in at least one of the main unit and the fixing unit.

9. The wearable device according to claim 1, further comprising:
a detection unit provided in at least one of the main unit and the fixing unit and including at least one of a biological detection sensor, a movement detection sensor, a gyro sensor, a temperature sensor, and a humidity sensor.

10. The wearable device according to claim 1, further comprising:
a payment module provided in at least one of the main unit and the fixing unit.

11. The wearable device according to claim 1, wherein the fixing unit includes
an auxiliary function unit including at least one of a power supply unit, a detection unit, a camera, and a payment module.

12. A wearable device comprising:
a main unit including a first communication unit and a user interface (UI) state module and configured to provide an interaction with at least one of a user of the wearable device and an external device;
a replaceable fixing unit including a memory configured to store UI data and a second communication unit configured to transfer the stored UI data to the main unit, and configured to provide a fixing force to fix the replaceable fixing unit to the user when the wearable device is worn by the user; and
wherein the first communication unit is configured to receive the UI data from the second communication unit and the UI state module is configured to provide the interaction based on the transferred UI data.

13. The wearable device according to claim 12, wherein the second communication unit initiates the transfer of the UI data when a wireless session between the first communication unit and the second communication unit is established.

14. The wearable device according to claim 12,
wherein the first communication unit includes a first communication port,
wherein the second communication unit includes a second communication port configured to correspond to the first communication port, and
wherein the main unit and the fixing unit are configured to be connected by the first communication port and the second communication port.

15. The wearable device according to claim 14, wherein the second communication unit initiates the transfer of the UI data when the first communication port is connected to the second communication port.

16. The wearable device according to claim 12, wherein the main unit displays that the main unit is connected to a data unit when the main unit is connected to the fixing unit.

17. The wearable device according to claim 16, wherein the main unit receives an input of whether a currently connected data unit is a previously connected data unit or a newly connected data unit.

18. The wearable device according to claim 16, wherein the main unit determines whether a currently connected data unit is a previously connected data unit or a newly connected data unit, and displays the determination on a GUI.

19. The wearable device according to claim 16, wherein, when a currently connected data unit is a newly connected data unit, the main unit receives an input of a pin number of the data unit.

20. The wearable device according to claim 16, wherein, when UI data is received from a currently connected data unit, the main unit receives an input for switching to the interaction based on the received UI data.

21. The wearable device according to claim 12, wherein the replaceable fixing unit includes a wristband.

22. A main unit of a wearable device, the main unit comprising:
a first communication unit configured to receive user interface (UI) data from a fixing unit configured to provide a fixing force to fix the fixing unit to a user of the wearable device when the wearable device is worn by the user; and
a UI state module configured to provide an interaction with at least one of the user of the wearable device and an external device based on the received UI data.

23. A replaceable fixing unit of a wearable device, the replaceable fixing unit comprising:
a memory configured to store user interface (UI) data; and
a communication unit configured to transfer the UI data to a main unit configured to provide an interaction with at least one of a user of the wearable device and an external device,
wherein the replaceable fixing unit is configured to provide a fixing force to fix the replaceable fixing unit to the user when the wearable device is worn by the user.

24. A control method of a wearable device, the control method comprising:
detecting a connection between a main unit, configured to provide an interaction with at least one of a user of the wearable device and an external device, and a fixing unit configured to provide a fixing force to fix the fixing unit to the user when the wearable device is worn by the user;
transferring user interface (UI) data of the fixing unit to the main unit when a determination is made that the main unit is connected to the fixing unit; and
providing, by the main unit, an interaction with at least one of the user of the wearable device and an external device based on the transferred UI data.

25. The control method of the wearable device according to claim 24, wherein the providing of the interaction includes switching to the interaction based on the transferred UI data when the transferred UI data is received.

26. The control method of the wearable device according to claim 24, wherein the providing of the interaction includes displaying a GUI based on the transferred UI data.

27. The control method of the wearable device according to claim 24, further comprising:
storing current transferred current UI data and previous transferred UI data in the main unit.

28. The control method of the wearable device according to claim 27, wherein the providing of the interaction includes providing the interaction based on at least one of the current transferred UI data and the previous transferred UI data.

29. A control method of a wearable device, the control method comprising:
detecting a connection between a main unit, configured to provide an interaction with at least one of a user of the wearable device and an external device, and a fixing unit configured to provide a fixing force to fix the fixing unit to the user when the wearable device is worn by the user;
displaying, by the main unit, that the main unit is connected to a data unit when a determination is made that the main unit is connected to the fixing unit; and
transferring user interface (UI) data of the data unit to the main unit.

30. The control method of the wearable device according to claim 29,
wherein the fixing unit includes a second communication unit,
wherein the main unit includes a first communication unit, and
wherein the determination is made that the main unit is connected to the fixing unit when a wireless session between the first communication unit and the second communication unit is established.

31. The control method of the wearable device according to claim 29,
wherein the fixing unit includes a second communication port,
wherein the main unit includes a first communication port, and
wherein the determination is made that the main unit is connected to the fixing unit when the first communication port is connected to the second communication port.

32. The control method of the wearable device according to claim 29, further comprising:
receiving an input of whether a currently connected data unit is a previously connected data unit or a newly connected data unit before the UI data of the data unit is transferred to the main unit.

33. The control method of the wearable device according to claim 29, further comprising:
determining whether a currently connected data unit is a previously connected data unit or a newly connected data unit before the UI data of the data unit is transferred to the main unit; and
displaying, by the main unit, the determination on a GUI.

34. The control method of the wearable device according to claim 29, further comprising:
receiving, when a currently connected data unit is a newly connected data unit, an input of a pin number of the data unit before the UI data of the data unit is transferred to the main unit.

35. The control method of the wearable device according to claim 29, further comprising:
receiving, when the UI data is received from a currently connected data unit, an input of switching to the interaction based on the received UI data.

36. A wearable device comprising:
a display including a first communication interface configured to receive user interface data, and configured to display a graphical user interface based on the received user interface data; and
a wristband including a receptacle for the display such that the display is insertable into and removable from the wristband, and configured to be worn on a wrist of a user of the wearable device.

37. The wearable device according to claim 36, wherein the wristband includes a second communication interface and transfers the user interface data to the display when a connection between the first communication interface and second communication interface is established.

38. The wearable device according to claim 36, wherein the first communication interface is configured to receive the user interface data from a second communication interface in an external device when a connection between the first communication interface and second communication interface is established.
